(19) United States
(12) Patent Application Publication
(10) Pub. No.: US 2021/0221389 A1
(43) Pub. Date: Jul. 22, 2021

(54) SYSTEM AND METHOD FOR AUTONOMOUS VEHICLE SENSOR MEASUREMENT AND POLICY DETERMINATION

(71) Applicant: 3M INNOVATIVE PROPERTIES COMPANY, St. Paul, MN (US)

(72) Inventors: Andrew W. Long, Woodbury, MN (US); James B. Snyder, Minneapolis, MN (US); Panagiotis D. Stanitsas, Foster City, CA (US); James W. Howard, North Oaks, MN (US); Benjamin W. Watson, Hampshire (GB); Kenneth L. Smith, White Bear Lake, MN (US); James L. C. Werness, Jr., Edina, MN (US); Claire R. Donoghue, Reading (GB); Justin M. Johnson, Hudson, WI (US)

(21) Appl. No.: 17/051,523

(22) PCT Filed: May 13, 2019
(86) PCT No.: PCT/IB2019/053946

§ 371 Date: Oct. 29, 2020

Related U.S. Application Data
(60) Provisional application No. 62/671,264, filed on May 14, 2018.

(51) Int. Cl. B60W 50/02; G07C 5/08; B60W 50/029; G08G 1/0962; G08G 1/09

(52) U.S. Cl. CPC B60W 50/0205; G07C 5/0808; H04W 4/44; G08G 1/09623; G08G 1/091; B60W 50/029

(57) ABSTRACT

A system and method for determining a sensing capability of a PAAV and for performing at least one operation of the PAAV as a function of at least one policy applied to the sensing capability determined for the PAAV. A sensing capability of the PAAV is determined at least in part on sensor data received from at least one sensor accuracy measurement feature deployed along a pathway. At least one operation of the PAAV is performed as a function of at least one policy applied to the sensing capability determined for the PAAV.

### TECHNICAL FIELD

The present application relates generally to pathway articles and systems in which such pathway articles may be used.

### BACKGROUND

Current and next generation vehicles are increasingly including fully automated guidance system vehicles, semi-automated guidance system vehicles, and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS or traffic warnings, connect to smartphones, alert driver to other cars or dangers, keep the driver in the correct lane, show what is in blind spots and other features. Infrastructure increasingly has become more intelligent, installing systems to help autonomous vehicles move more safely and efficiently. Over the next several decades, vehicles of all types—manual, semi-automated and automated—may operate on the same roads and may need to operate cooperatively and synchronously for safety and efficiency.

While adaptive features of automated and semi-automated vehicles may operate well under ordinary circumstances, they do not adapt well to factors that reduce sensor capabilities of the vehicle. Sensor capabilities of a vehicle may be compromised by failure of a sensor or other vehicle device or by external factors such as snow or rain. Sensor capabilities of a vehicle may also be compromised via an intentional attempt to impair one or more sensors, such as a cybercriminal attack.

### SUMMARY

In general, this disclosure describes techniques by which autonomous vehicle navigation systems adapt to changes in sensor capabilities. In some examples, the current sensing capabilities of the vehicle are a function of the vehicle's navigation systems, including the sensors and the computational elements that work with the sensors. In other example approaches, external factors such as snow, rain or other environmental conditions, contribute to the measure of a vehicle's sensor capabilities.

Example autonomous vehicle navigation systems are described that capture and extract information encoded within one or more pathway markers (such as road signs) proximate the pathway to assess sensor capabilities of the vehicle and that may modify the operational rules of the vehicle to adapt to changes in sensor capabilities. As examples, a section of a pathway may include a modified section, such as a construction zone, an alternate route, or other temporary section of road, in which the semantics of road infrastructure (e.g., signs and pathway markings) are temporarily overridden with modified operational requirements for vehicles operating in the temporary zone. Sensor capabilities in the vehicle may be sufficient to navigate typical sections of the pathway but may not be sufficient to navigate the modified section. One or more policies established for the vehicle determine whether, given the current sensing capabilities of the vehicle, the vehicle is permitted to pass through particular sections of the pathway.

In some examples, a system comprises a pathway article assisted vehicle (PAAV) having one or more sensors, one or more sensor accuracy measurement features deployed along a pathway and at least one computing device comprising one or more processors connected to memory, wherein the memory includes instructions that, when executed by the one or more processors, cause the processors to receive captured sensor data from each respective sensor, the captured sensor data generated by sensing, with the respective sensor, at least one of the sensor accuracy measurement features deployed along the pathway; determine a sensing capability for the PAAV, wherein the sensing capability for the PAAV is based at least in part on the captured sensor data for each respective sensor and of expected sensor data for each respective sensor; and perform at least one operation of the PAAV as a function of at least one policy applied to the sensing capability determined for the PAAV.

In another example, a computing device comprises memory and one or more processors connected to the memory. The memory includes instructions that, when executed by the one or more processors, cause the computing device to receive captured sensor data from each respective sensor, the captured sensor data generated by sensing, with the respective sensor, at least one of the sensor accuracy measurement features deployed along the pathway; determine a sensing capability for a pathway article assisted vehicle (PAAV), wherein the sensing capability for the PAAV is a function of the captured sensor data for each respective sensor and of expected sensor data for each respective sensor; and perform at least one operation of the PAAV as a function of at least one policy applied to the sensing capability determined for the PAAV.

In another example, a road-side unit comprises an interface, a memory and one or more processors coupled to the memory. The memory comprises instructions that, when executed by the one or more processors, cause the processors to output, via the interface, an indication of upcoming one or more sensor accuracy measurement features on a pathway, the sensor accuracy measurement features detectable by a system comprising a pathway article assisted vehicle (PAAV) having one or more sensors for respective sensor modalities, for evaluating sensor accuracy for each of the one or more sensors.

In yet another example, a method comprises receiving captured sensor data from each respective sensor, the captured sensor data generated by sensing, with the respective sensor, at least one of the sensor accuracy measurement features deployed along the pathway; determining a sensing capability for a pathway article assisted vehicle (PAAV), wherein the sensing capability for the PAAV is based at least in part on the captured sensor data for each respective sensor and of expected sensor data for each respective sensor; and performing at least one operation of the PAAV as a function of at least one policy applied to the sensing capability determined for the PAAV.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system with pathway articles that are configured to be interpreted by a PAAV, in accordance with techniques of this disclosure.

FIG. 2 is a block diagram illustrating a sensor capability testing zone, in accordance with techniques of this disclosure.

FIGS. 3A and 3B are block diagrams illustrating pathway articles that may be used in a sensor capability testing zone, in accordance with techniques of this disclosure.

FIG. 4 is a block diagram illustrating an example computing device, in accordance with techniques of this disclosure.

FIG. 5 is a flow diagram illustrating example operation of a computing device for directing operation of a pathway-article assisted vehicle, in accordance with techniques of this disclosure.

FIG. 6 is a flow diagram illustrating example operation of a computing device for determining permitted movement of a pathway-article assisted vehicle, in accordance with techniques of this disclosure.

FIG. 7 is a diagram of an example roadway that may be navigated by a pathway-article assisted vehicle, in accordance with techniques of this disclosure.

FIG. 8 is a flow diagram illustrating example operation of a computing device for determining permitted movement of a pathway-article assisted vehicle, in accordance with techniques of this disclosure.

FIG. 9 is a block diagram illustrating an example policy control system, in accordance with techniques of this disclosure.

FIG. 10 is a flow chart illustrating an example method of determining a level of autonomy allowed to a vehicle, in accordance with techniques of this disclosure.

FIG. 11 is a conceptual diagram of a cross-sectional view of a pathway article, in accordance with techniques of this disclosure.

FIGS. 12A and 12B illustrate cross-sectional views of portions of an article message formed on a retroreflective sheet, in accordance with techniques of this disclosure.

### DETAILED DESCRIPTION

Autonomous vehicles and ADAS, which may be referred to as semi-autonomous vehicles, may use various sensors to perceive the environment, infrastructure, and other objects around the vehicle. Examples of sensors (or “infrastructure sensors”) may include but are not limited to one or more of image sensors, LiDAR, acoustic sensors, radar, Global Positioning Satellite (GPS) location of infrastructure article, devices for detecting time of contact with infrastructure articles, and weather sensors for weather measurement at the time an infrastructure article is detected. These various sensors combined with onboard computer processing may allow the automated system to perceive complex information and respond to it more quickly than a human driver. In this disclosure, a vehicle may include any vehicle that operates with sensors, onboard or remotely, that are used to interpret a vehicle pathway.

A vehicle with vision systems or other sensors, onboard or remote, that take cues from the vehicle pathway may be called a pathway-article assisted vehicle (PAAV). Some examples of PAAVs may include the fully autonomous vehicles and ADAS-equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. A vehicle pathway may be a road, highway, a warehouse aisle, factory floor or a pathway not connected to the earth's surface. The vehicle pathway may include portions not limited to the pathway itself. In the example of a road, the pathway may include the road shoulder, physical structures near the pathway such as toll booths, railroad crossing equipment, traffic signs, traffic lights, the sides of a mountain, guardrails, and generally encompassing any other properties or characteristics of the pathway or objects/structures in proximity to the pathway. This will be described in more detail below.

Connected and autonomous vehicles utilize numerous environmental sensors. These sensors operate as necessary input into both the efficiency and safety of the navigation system. Care should be taken, therefore, to ensure these sensors are operating accurately. In some examples, as described below, ADAS or autonomous vehicle systems assess the current performance of their sensors. This assessment may happen via an a priori agreement of sensed features, or via those same features but, with an active confirmation component. Vehicles equipped with sensor capability determination systems, or which have access to such systems, can assess the capabilities of their sensors and, in some examples, may be capable of taking steps to ensure continued safe operation despite any diminishment in sensor capabilities.

As noted above, while adaptive features of automated and semi-automated vehicles may operate well under ordinary circumstances, they do not adapt well to factors that reduce sensor capabilities of the vehicle. Sensor capabilities of a vehicle may be compromised by failure of a sensor or other vehicle device or by external factors such as a cybercriminal attack, the amount of light or weather conditions like snow or rain. Diminished sensor capabilities may still be sufficient to allow a vehicle to navigate a construction-free section of a road or a street, such as navigation within lane boundaries, but may not be adequate to navigate that same section during construction. In some cases, sensor capabilities at various diminished capacities may correspond to a maximum allowable level of autonomy for a PAAV.

On the other hand, it can be advantageous to permit operation of PAAVs even if they have degraded sensing capabilities. Techniques are described herein by which autonomous vehicle navigation systems adapt to changes in sensor capabilities. In some examples, the current sensing capabilities of the vehicle are a function of the capabilities of the vehicle's navigation systems, including the sensors and the computational elements that work with the sensors. In other example approaches, external factors such as snow, rain or other environmental conditions, or a cybercriminal attack, contribute to the measure of a vehicle's sensor capabilities. Vehicles equipped with sensor capability determination systems, or which have access to such systems, are capable of operating over a wider variety of conditions, even with impaired or degraded sensor suites. Such systems also increase vehicle safety and may be used to establish policies for the safe operation of vehicles across a variety of conditions and despite degraded sensor capabilities. Such a system can further be used to operate as a standard calibration/validation tool that may be used by other equipment manufacturers and by departments of transportation to set policies about the level of automation which may be used given current sensing capabilities. Further, the data collected by this system may further be collected and sold to third parties.

Vehicles equipped with sensor capability determination systems, or which have access to such systems, are also capable of self-healing. In one example approach, for instance, if a vehicle control system becomes aware through its sensor capability determination system that a sensor is inoperative or degraded, it takes steps to bolster ways of obtaining the necessary information from pathway articles. In one such example approach, the vehicle control system recalibrates the problem sensor. In some such example approaches, this recalibration is done based on vehicle standard recalibration procedures.

A pathway article, such as an enhanced sign or enhanced pavement markings, in accordance with the techniques of this disclosure may include an article message on the physical surface of the pathway article. In this disclosure, an article message may include images, graphics, characters, such as numbers or letters or any combination of characters, symbols or non-characters. An article message may include human-perceptible information and machine-perceptible information. Human-perceptible information may include information that indicates one or more first characteristics of a vehicle pathway primary information, such as information typically intended to be interpreted by human drivers. In other words, the human-perceptible information may provide a human-perceptible representation that is descriptive of at least a portion of the vehicle pathway. As described herein, human-perceptible information may generally refer to information that indicates a general characteristic of a vehicle pathway and that is intended to be interpreted by a human driver. For example, the human-perceptible information may include words (e.g., “dead end” or the like), symbols, graphics (e.g., an arrow indicating the road ahead includes a sharp turn) or shapes (e.g., signs or lane markings). Human-perceptible information may include the color of the article, the article message or other features of the pathway article, such as the border or background color. For example, some background colors may indicate information only, such as “scenic overlook” while other colors may indicate a potential hazard (e.g., the red octagon of a stop sign, or the double yellow line of a no passing zone).

In some instances, the human-perceptible information may correspond to words or graphics included in a specification. For example, in the United States (U.S.), the human-perceptible information may correspond to words or symbols included in the Manual on Uniform Traffic Control Devices (MUTCD), which is published by the U.S. Department of Transportation (DOT) and includes specifications for many conventional signs for roadways. Other countries have similar specifications for traffic control symbols and devices. In some examples, the human-perceptible information may be referred to as primary information.

According to aspects of this disclosure, a pathway article may also include second, additional information that may be interpreted by a PAAV. As described herein, second information or machine-perceptible information may generally refer to additional detailed characteristics of the vehicle pathway. The machine-perceptible information is configured to be interpreted by a PAAV, but in some examples, may be interpreted by a human driver. In other words, machine-perceptible information may include a feature of the graphical symbol that is a computer-interpretable visual property of the graphical symbol. In some examples, the machine-perceptible information may relate to the human-perceptible information, e.g., provide additional context for the human-perceptible information. In an example of an arrow indicating a sharp turn, the human-perceptible information may be a general representation of an arrow, while the machine-perceptible information may provide an indication of the shape of the turn including the turn radius, any incline of the roadway, a distance from the sign to the turn, or the like. The additional information may be visible to a human operator; however, the additional information may not be readily interpretable by the human operator, particularly at speed. In other examples, the additional information may not be visible to a human operator but may still be machine readable and visible to a vision system of a PAAV. In some examples, an enhanced pathway article may be an optically active article in that the pathway article is readily detectible by vision systems, which may include an infrared camera or other camera configured for detecting electromagnetic radiation in one or more bands of the electromagnetic spectrum, which may include the visible band, the infrared band, the ultraviolet band, and so forth. For example, the pathway articles may be reflective, such as retroreflective, within one or more bands of the electromagnetic spectrum that are readily detectible by visions systems of the computing device 116.

A successful implementation of infrastructure and infrastructure support, such as the pathway articles of this disclosure may include redundant sources of information to verify inputs and ensure the vehicles make the appropriate response. The techniques of this disclosure may provide pathway articles with an advantage for intelligent infrastructures, because such articles may provide information that can be interpreted by both machines and humans. This may allow verification that both autonomous systems and human drivers are receiving the same message.

Redundancy and security may be of concern for a partially and fully autonomous vehicle infrastructure. Properly configured pathway articles may be used as trusted points of reference used to validate connected and autonomous vehicle behavior as being appropriate in accordance with the rules of the road and the current situation. In some example approaches, these trusted points of reference may form part of a new blockchain based solution to provide increased depth and breadth of security, through mutually authenticating peers. In one example approach, information from authenticating peers may be compared and combined with each other to validate safety indicators and vehicle behaviors such as vehicle proximity, orientation, velocity and the relative direction of the roadside materials to the vehicle. This shared authentication may then be used to highlight unauthorized transactions or actions/transactions. For example, a lack of mutual authentication may indicate a potential threat to road safety and may result in immediate intervention. In one example approach, the vehicle ledger may be used in post event analysis of the exception or, in the aggregate as an interstate level record of vehicle events and transactions.

The techniques of this disclosure may be used to provide local, onboard, redundant validation of information received from onboard sensors, from GPS and from the cloud. In one example approach, the pathway articles provide a basis to compare external trusted points of reference with both the actual behavior of the vehicle and the intentions of the driver. This behavior can be further cross referenced against environmental conditions and driving conditions to ensure safety for road users, while reducing traffic accidents and congestion.

The pathway articles of this disclosure may provide additional information to autonomous systems in a manner which is at least partially perceptible by human drivers. Moreover, the techniques of this disclosure may provide solutions that may support the long-term transition to a fully autonomous infrastructure because it can be implemented in high impact areas first and expanded to other areas as budgets and technology allow.

Pathway articles of this disclosure, such as enhanced sign or pavement markings, may provide additional information that may be processed by the onboard computing systems of the vehicle, along with information from the other sensors on the vehicle that are interpreting the vehicle pathway. The pathway articles of this disclosure may also have advantages in applications such as for vehicles operating in warehouses, factories, airports, airways, waterways, underground or pit mines and similar locations. Enhanced signs include but are not limited to traffic signs, temporary traffic control materials, vests, license plates, conspicuity tapes, registration labels and validation stickers.

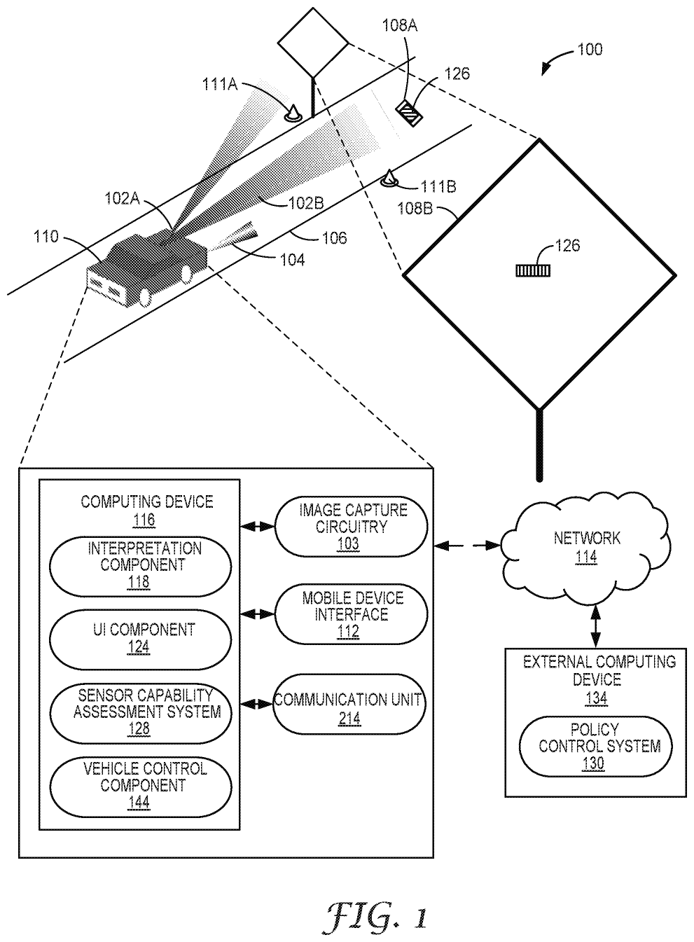

FIG. 1 is a block diagram illustrating an example system with pathway articles that are configured to be interpreted by a PAAV, in accordance with techniques of this disclosure. As described herein, PAAV generally refers to a vehicle with a vision system, along with other sensors, that may interpret the vehicle pathway and the vehicle's environment, such as other vehicles or objects. A PAAV may interpret information from the vision system and other sensors, make decisions and take actions to navigate the vehicle pathway.

As shown in FIG. 1, system 100 includes PAAV 110 that may operate on vehicle pathway 106 and that includes image capture devices 102A and 102B and onboard computing device 116. Any number of image capture devices may be possible. The illustrated example of system 100 also includes one or more pathway articles 108 as described in this disclosure, such as pavement marker 108A and sign 108B, and one or more pathway articles 111 as described in this disclosure, such as construction pavement marker 111A and construction pavement marker 111B. Each pathway article 108 and pathway article 111 includes information that may be read by sensors such as image capture devices 102A and 102B, or by sensors operating in different modalities. Pathway articles 108 or features thereof may function as sensor accuracy measurement features for evaluating sensors of PAAV, as described further herein.

In the example shown in FIG. 1, pavement marker 108A is placed along the direction of traffic flow. In other example approaches, pavement markers 108A may be placed alongside the pathway 106 to be scanned by a sideways facing sensor as PAAV 110 passes. In some examples, pathway articles 108A, 108B are deployed in a pre-defined or otherwise known pattern that is detectible by computing device 116. In some example approaches, construction pavement markers 111A and 111B are placed along the direction of traffic flow to indicate the presence of a construction zone or may be placed alongside the pathway 106 to be scanned by a sideways facing sensor as PAAV 110 passes. In some examples, construction pavement markers 111A and 111B are deployed in a pre-defined or otherwise known pattern that is detectible by computing device 116.

In one example, interpretation component 118 may obtain, from image capture device(s) 102 via image capture circuitry 103, an image that includes representations of patterns within each pathway article 108. Interpretation component 118 may identify the pattern by determining distances 109A, 109B between the pathway articles 108 using one or more image processing algorithms. Interpretation component 118 may map the pattern to validation information in a pattern dictionary that maps patterns to validation information, where the validation information may, e.g., identify a location, a vehicle operation context such as a speed limit for a location associated with a location, a pathway characteristic, or other parameter usable for validating the PAAV 110 operation.

Vehicle pathway 106 may be a road, highway, a warehouse aisle, factory floor, or a pathway not connected to the earth's surface. Vehicle pathway 106 may include portions not limited to the pathway itself. In the example of a road, vehicle pathway 106 may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway.

Vehicle pathway 106 may include a temporary zone on vehicle pathway 106. The temporary zone may represent a section of vehicle pathway 106 that includes temporary changes to pathway infrastructure. For example, the temporary zone may include a construction zone, a school zone, an event zone, an emergency zone, an alternate route, or other temporary section of road with changes to road infrastructure in which, for instance, the ordinary semantics of the road infrastructure are temporarily overridden, by a governmental or other authority, with modified operational requirements for vehicles operating in the temporary zone. A temporary change to pathway infrastructure may include a variety of lengths of time, including a short period, such as hours, or a longer period, such as a year.

As such, a temporary zone may have navigational characteristics that deviate from ordinary navigational characteristics of vehicle pathway 106. For example, the temporary zone may have navigational characteristics such as a traffic pattern change, worker presence, lane modifications, road surface quality, construction standards change, or other conditions that are not normally present on or near vehicle pathway 106. The navigational characteristics of the temporary zone may have associated operating rules for safely navigating the temporary zone that deviate from ordinary operating rules of vehicle pathway 106. For example, a temporary zone that includes a degraded road surface quality may have an associated lower speed limit, longer braking distance, and/or control system biased more toward traction control than an ordinary road surface. Additionally, or alternatively, a given level of autonomous operation may not be suitable for the temporary zone. For example, a level of autonomous operation that is conditioned on a driver safely assuming operation of the vehicle in the event of an irregular hazard may not be suitable for a temporary zone for which there may be unexpected changes in features that may not allow for a timely and safe assumption of operation. As such, the temporary zone may have associated restrictions on levels of autonomous operation of vehicles.

For example, during normal operation, vehicle pathway 106 may be a relatively low traffic roadway that includes a two-way stop sign at a cross-section of a higher traffic roadway. Due to construction that reroutes traffic along vehicle pathway 106, vehicle pathway 106 may contain a temporary zone—in this example, a detour to a construction zone—that is configured for higher-than-normal road volume along vehicle pathway 106 relative to the higher traffic roadway. As such, the two-way stop of vehicle pathway 106 may be converted to a temporary four-way stop characterized by, for example, covers over the two-way stop signs and flashing red lights facing each direction of the two traffic roadways. Navigational characteristics of the temporary four-way stop may include a superseded two-way stop indication and an overriding four-way stop indication, as well as ordinary navigational characteristics of the roadway such as lane boundaries. As such, to autonomously or semi-autonomously navigate the temporary four-way stop, PAAV 110 may have an ability to recognize the superseded two-way stop indication, recognize the overriding four-way stop indication, and navigate the four-way stop using the four-way stop indication and/or other environmental factors indicative of the four-way stop. Such ability may correspond to, for example, level 4 driving automation as defined by Society for Automotive Engineers J3016 (“Surface Vehicle Recommended Practice” standard).

PAAV 110 of system 100 may be an autonomous or semi-autonomous vehicle, such as an ADAS, that takes cues from vehicle pathway 106 using vision systems or other sensors. In some examples, PAAV 110 may include occupants that may take full or partial control of PAAV 110. PAAV 110 may be any type of vehicle designed to carry passengers or freight including small electric powered vehicles, large trucks or lorries with trailers, vehicles designed to carry crushed ore within an underground mine, or similar types of vehicles. PAAV 110 may include lighting, such as headlights in the visible light spectrum as well as light sources in other spectrums, such as infrared. Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. PAAV 110 may use various sensors to perceive the environment, infrastructure, and other objects around the vehicle. PAAV 110 may include other sensors such as radar, sonar, LiDAR, GPS and communication links for sensing the vehicle pathway, other vehicles in the vicinity, environmental conditions around the vehicle and communicating with infrastructure. For example, a rain sensor may operate the vehicles windshield wipers automatically in response to the amount of precipitation and may also provide inputs to the onboard computing device 116. These various sensors combined with onboard computer processing may allow the automated system to perceive complex information and respond to it more quickly than a human driver, as will be explained further below.

In general, image capture devices 102 may be used to gather information about pathway 106. Image capture devices 102 may send image capture information to computing device 116 via image capture circuitry 103. Image capture devices 102 may capture lane markings, centerline markings, edge of roadway or shoulder markings, as well as the general shape of the vehicle pathway. The general shape of a vehicle pathway may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110 as well as be able to widen or narrow focus. In some examples, image capture devices 102 may include a first lens and a second lens. PAAV 110 may have more or fewer image capture devices 102 in various examples.

Image capture devices 102 may include one or more image capture sensors and one or more light sources. In some examples, image capture devices 102 may include image capture sensors and light sources in a single integrated device. In other examples, image capture sensors or light sources may be separate from or otherwise not integrated in image capture devices 102. As described above, PAAV 110 may include light sources separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more light sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. In addition, one or more light sources 104 may emit radiation in the near-infrared spectrum.

In the example of FIG. 1, image capture devices 102 may be communicatively coupled to computing device 116 via image capture circuitry 103. Image capture circuitry 103 may receive image information from the plurality of image capture devices, such as image capture devices 102, perform image processing, such as filtering, amplification and the like, and send image information to computing device 116.

Other components of PAAV 110 that may communicate with computing device 116 may include image capture circuitry 103, described above, mobile device interface 112, and communication unit 214. In some examples image capture circuitry 103, mobile device interface 112, and communication unit 214 may be separate from computing device 116 and in other examples may be a component of computing device 116.

In the example of FIG. 1, pathway 106 includes pathway article 108, which may be proximate to (i.e. in, adjacent, or leading up to) the temporary zone of pathway 106. Pathway article 108 may include a variety of indicators and/or markers. For example, pathway article 108 may include one or more of an optical tag, a road sign, a pavement marker, a radio-frequency identification, a radio-frequency tag, an acoustic surface pattern, and a material configured to provide a RADAR signature to a RADAR system.

Pathway articles 108A and 108B in FIG. 1 include pathway article messages 126. Each pathway article message 126 may be detectable by at least one image capture device, such as image capture devices 102, mounted within PAAV 110. Pathway article message 126 may include, but is not limited to characters, images, and/or any other information that may be printed, formed, or otherwise embodied on pathway article 108. For example, each pathway article 108 may have a physical surface having pathway article message 126 embodied thereon. In some examples, pathway article message 126 may be encoded via a 2-dimensional bar code. For example, the 2-dimensional bar code may be a QR code. Additional examples of physical surfaces having a pathway article message 126 embodied thereon are described in further detail below.

In some cases, a value associated with pathway article message 126 may be stored to a Radio Frequency IDentification (RFID) device and accessible using an RFID reader of PAAV 110. In some cases, computing device 116 may access the value associated with pathway article message 126 using other types of communications, such as Near-field communication (NFC) protocols and signals; RADAR, laser, or infrared-based readers, or other communication type. In some cases, pathway article message 126 may not be affixed to a separate pathway article.

In some examples, pathway article messages 126 indicate a temporary zone of vehicle pathway 106, which may be proximate to its corresponding pathway article 108. As will be described below, pathway article message 126 may be configured to cause a computing device to modify a mode of autonomous operation of PAAV 110 while PAAV 110 is operating within the temporary zone on vehicle pathway 106. Pathway article message 126 may also provide access, directly or indirectly (e.g., via a link to a datastore), to information related to navigation of the temporary zone. In some examples, pathway article message 126 may include a plurality of components or features that provide information related to navigation of the temporary zone.

In one such example approach, a temporary zone, or section leading up to a temporary zone, of pathway 106 may include construction pavement markers 111A and 111B, collectively referred to as markers 111. Markers 111 may be configured to indicate a feature of the temporary zone of pathway 106. For example, markers 111 may indicate a beginning of the temporary zone of pathway 106, a lateral limit of the temporary zone of pathway 106, or another feature associated with the temporary zone of pathway 106. Markers that may be used include, but are not limited to, cones, barrels, paint, and the like. In some examples, markers 111 may include machine-readable identifiers that indicate the feature of the temporary zone. For example, markers 111 may include a code or pattern that corresponds to a programmable action for PAAV 110. As an example, a cone may include a pattern that is configured to indicate a rightmost road edge to a PAAV travelling in a southbound direction and a leftmost road edge to a PAAV travelling in a northbound direction. Such markers 111 may provide guidance to PAAV 110 in temporary zones for dynamic and/or temporary traffic control.

As will be described further below, pathway article message 126 may indicate a variety of types of information. In some examples, pathway article message 126 may, for instance, provide computing device 116 with static information related to the temporary zone. Static information may include any information that is related to navigation of the temporary zone, associated with pathway article message 126, and not subject to change. For example, certain features of temporary zones may be standardized and/or commonly used in various temporary zones, such that pathway article message 126 may correspond to a pre-defined classification or operating characteristic of the temporary zone. As some examples, pathway article message 126 may indicate a beginning of the temporary zone, a navigational characteristic or feature of the temporary zone, a threshold level of autonomous operation of the temporary zone, an operating rule or set of operating rules of the temporary zone, or the like.

In some examples, pathway article message 126 may provide computing device 116 with dynamic information related to the temporary zone. Dynamic information may include any information that is related to navigation of the temporary zone, associated with pathway article message 126, and subject to change. For example, certain features of temporary zones may be unique to the temporary zone or may change frequently, such that pathway article message 126 may correspond to a classification or operating characteristic that is subject to change based on the changing features and updated based on the changing features. In some examples, pathway article message 126 may indicate a link to an external computing device, such as external computing device 134, that maintains real-time information regarding current classifications or operating characteristics of the temporary zone.

In some examples, pathway article 108 includes additional components that convey other types of information, such as one or more security elements. For example, a security element may be any portion of pathway article message 126 that is printed, formed, or otherwise embodied on pathway article 108 that facilitates the detection of counterfeit pathway articles. Pathway article 108 may also include additional information that represents navigational characteristics of vehicle pathway 106 that may be printed, or otherwise disposed in locations that do not interfere with the graphical symbols. In some examples, pathway article 108 may include components of pathway article message 126 that do not interfere with the graphical symbols by placing the additional machine-readable information so it is detectable outside a visible light spectrum. This may have advantages of avoiding interfering with a human operator interpreting pathway article 108, providing additional security. For example, pathway article message 126 of an enhanced sign may be formed by different areas that either retroreflect or do not retroreflect light, non-visible components in FIG. 1 may be printed, formed, or otherwise embodied in a pathway article using any light reflecting technique in which information may be determined from non-visible components. For instance, non-visible components may be printed using visibly-opaque, infrared-transparent ink and/or visibly-opaque, infrared-opaque ink. In some examples, non-visible components may be placed on pathway article 108 by employing polarization techniques, such as right circular polarization, left circular polarization or similar techniques.

In some examples, pathway article 108 includes one or more signs having image data embodied thereon, the image data encoded with the code. For example, pathway article 108 may include a physical surface having an optical element embodied thereon, such that the optical element embodies the code indicative of the temporary zone. In some examples, pathway article 108 may further include an article message that includes a human-perceptible representation of pathway information for the vehicle pathway.

In some examples, pathway article 108 may be an enhanced sign that includes a reflective, non-reflective, and/or retroreflective sheeting attached to a base surface of the enhanced sign. One such enhanced sign is shown in the pathway article 108B shown in FIG. 1. The sheeting has a physical surface and may include authentication information, such as the security elements described above. In this example, a reflective, non-reflective, and/or retroreflective sheet may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

In some examples, pathway articles 108 may include information at different levels of resolution such as that a sensor with the modality (e.g., image-based, LiDAR, acoustic pavement, etc.) corresponding to a pathway article can detect different levels of resolution based on the capability of the sensor when detecting the information. The capability of the sensor may be dependent on an inherent capability of the sensor (e.g., camera resolution), the environmental conditions at the time of the sensing the pathway article, the roadway conditions at the time of sensing the pathway article, or other factors.

Although described above, in some examples, with respect to identifying a temporary zone on a pathway 106, the techniques herein may be applied for sensor evaluation generally and are not limited to evaluating sensor capability for entering a temporary zone. For example, the techniques may be used for evaluating sensor capabilities for PAAV operation on a given length of the pathway 106 (e.g., the next 50 miles) in accordance with a policy for that length of the pathway 106, or may be used to evaluate a default or normal operation of PAAV 110.

Mobile device interface 112 may include a wired or wireless connection to a smartphone, tablet computer, laptop computer or similar device. In some examples, computing device 116 may communicate via mobile device interface 112 for a variety of purposes such as receiving traffic information, an address of a desired destination or other purposes. In some examples computing device 116 may communicate to external networks 114, e.g. the cloud, via mobile device interface 112.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles, such as information interpreted from pathway article 108. In some examples, communication units 214 may transmit and/or receive satellite signals on a satellite network such as a Global Positioning System (GPS) network. In some examples, communications units 214 may transmit and/or receive data to a remote computing system, such as computing device 134, through network 114.

In the example of FIG. 1, computing device 116 includes an interpretation component 118, a user interface (UI) component 124, a sensor capability assessment system 128, and a vehicle control component 144. Components 118, 124, 128, and 144 may perform operations described herein using software, hardware, firmware, or a mixture of both hardware, software, and firmware residing in and executing on computing device 116 and/or at one or more other remote computing devices. In some examples, components 118, 124, 128, and 144 may be implemented as hardware, software, and/or a combination of hardware and software.

Computing device 116 may execute components 118, 124, 128, and 144 with one or more processors. Computing device 116 may execute any of components 118, 124, 128, 144 as or within a virtual machine executing on underlying hardware. Components 118, 124, 128, 144 may be implemented in various ways. For example, any of components 118, 124, 128, 144 may be implemented as a downloadable or pre-installed application or “app.” In another example, any of components 118, 124, 128, 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110. In some examples, UI component 124 includes outputs to a user such as displays, such as a display screen, indicator or other lights, audio devices to generate notifications or other audible functions. UI component 124 may also include inputs such as knobs, switches, keyboards, touch screens or similar types of input devices.

Interpretation component 118 may be configured to receive an image of an indication of a temporary zone and process the image of the temporary zone to obtain the indication of the temporary zone. In examples in which the indication of the temporary zone is pathway article message 126, interpretation component 118 may be configured to receive an image of pathway article message 126 and process the image of pathway article message 126 to extract a pathway article message. For example, interpretation component 118 may be communicatively coupled to at least one of image capture devices 102 and configured to receive the image of pathway article message 126 from the at least one of image capture devices 102. Interpretation component 118 may be configured to process the image of pathway article message 126 to extract the corresponding pathway article message, such as by using image processing techniques.

In examples, where the indication of the temporary zone includes pathway article messages 126, once interpretation component 118 has extracted a pathway article message from a pathway article message 126, interpretation component 118 may be configured to interpret pathway article message 126 to obtain information related to navigation of the temporary zone. In some examples, interpretation component 118 may use decoding information to determine the information related to navigation of the temporary zone from pathway article message 126. In some examples, such as where decoding information regarding pathway article message 126 is stored on computing device 116, interpretation component 118 may obtain the information on a pathway article message 126 by looking up an image of the pathway article message 126 in a datastore or other log. In some examples, such as where decoding information regarding pathway article message 126 is stored remotely, interpretation component 118 may send the pathway article message to an external datastore for decoding, such as to an external datastore of computing device 134. In this way, interpretation component 118 may provide information, directly or indirectly, to vehicle control component 144 related to navigation of the temporary zone. As will be described below, the provided information may be used to modify a mode of autonomous operation of PAAV 110.

In some examples, information related to navigation of the temporary zone includes a set of operating rules (also referred to as an “operating rule set”) used by PAAV 110 to navigate the temporary zone. For example, as will be explained below, vehicle control component 144 may operate according to operating rules of one or more operating rule sets. An operating rule may be any navigational rule based on navigational characteristics of pathway 106, including the temporary zone, and associated with autonomous or semi-autonomous operation of PAAV 110. An operating rule set may describe navigational characteristics of the temporary zone. For example, a temporary zone may have specific navigational characteristics that require or recommend a specific operating rule set. The specific operating rule set may, for example, change a priority of information received from sensors, change a response of PAAV 110 to a navigational stimulus, and the like. A change in an operating rule set of PAAV 110 may result in a change in how PAAV 110 responds to a navigational stimulus. Operating rules that may be used include, but are not limited to, speed limits, acceleration limits, braking limits, following distance limits, lane markings, distance limits from workers, and the like.

In some examples, pathway article message 126 includes or indicates an operating rule set for PAAV 110 to navigate the temporary zone. Interpretation component 118 may obtain the operating rule set based on the interpretation of pathway article message 126. For example, pathway article message 126 may indicate a specific operating rule set associated with the temporary zone. In some examples, interpretation component 118 may obtain the operating rule set from storage (e.g. memory) located on computing device 116. For example, pathway article message 126 may be a standardized code associated with a category of temporary zone, such that interpretation component 118 may look up the operating rule set associated with that category of temporary zone. As another example, pathway article message 126 may indicate a set of one or more operations to be applied by PAAV 110, such as “apply brakes” or “switch to driver control” or “move to left lane.” In such examples, interpretation component 118 accesses a local or remote data structure mapping pathway article message 126 to the set of operations to be applied by PAAV 110 and provides the set of operations to vehicle control component 144 to modify the operation of the PAAV 110.

In some examples, interpretation component 118 may obtain the operating rule set from an external device, such as computing device 134 through network 114. For example, interpretation component 118 may output a request to computing device 134 for the operating rule set. For example, a temporary zone may include unique navigational characteristics that utilize a unique operating rule set. By including an operating rule set on a centralized server, such as a server controlled by a same entity as the temporary zone, PAAV 110 may PAAV may better navigate the temporary zone based on the operating rule set.

In some examples, information related to navigation of the temporary zone includes a classification of the temporary zone that corresponds to a level of autonomous operation of PAAV 110. For example, a temporary zone may be classified based on a complexity of the navigational characteristics of the temporary zone. In some instances, this classification may correspond to an upper limit on autonomous operation within the temporary zone. For example, a temporary zone may be so complex that autonomous operation of a vehicle through the temporary zone may be limited to levels of autonomous operation in which a human driver monitors the driving environment (i.e. levels 0-2 of SAE J3016). In some instances, this classification may correspond to a lower limit on autonomous operation within the temporary zone. For example, a temporary zone may include sudden and unpredictable infrastructure changes, such that autonomous operation of a vehicle may be limited to levels of autonomous operation in which a human driver is not a fallback performer (i.e. levels 4-5 of SAE J3016). A change in a level of autonomous operation of PAAV 110 may result in a change in how PAAV 110 responds to a particular navigational stimulus.

In some examples, pathway article message 126 indicates a level of autonomous operation of PAAV 110 required to navigate the temporary zone. Interpretation component 118 may obtain a level of autonomous operation of PAAV 110 based on the interpretation of pathway article message 126. In some examples, pathway article message 126 may indicate a threshold level of autonomous operation for the temporary zone. For example, a temporary zone may not be safe for a high level of autonomous operation due to navigational characteristics of the temporary zone, such as complex instructions or particular safety considerations such as unpredictable operations of road workers and road working equipment. As such, pathway article message 126 may indicate a maximum level of autonomous operation permitted for PAAV 110 within the temporary zone. As another example, a temporary zone may not be safe for a low level of autonomous operation due to navigational characteristics of the temporary zone, such as features that may not allow a hand-off to an operator. As such, pathway article message 126 may indicate a minimum level of autonomous operation permitted for PAAV 110 within the temporary zone. In some examples, interpretation component 118 may obtain the level of autonomous operation locally, such as from storage located on computing device 116, or remotely, such as from storage located on computing device 134.

In some examples, computing device 116 may use information from interpretation component 118 to generate notifications for a user of PAAV 110, e.g., notifications that indicate a navigational characteristic or condition of vehicle pathway 106. For example, in response to interpretation component 118 obtaining pathway article message 126 corresponding to a temporary zone, computing device 116 may output a notification that PAAV 110 is approaching a temporary zone. The notification may notify an operator of PAAV 110 that the operator may be required to resume manual operation of PAAV 110.

In some examples, vehicle control component 144 may determine a classification of a temporary zone based on navigational characteristics of the temporary zone. For example, the operating characteristics of the temporary zone may frequently change based on local conditions, such as traffic and weather, that are outside the control of operators of the temporary zone. As such, rather than rely solely on static or dynamic information from, for example, an indication of the temporary zone such as pathway article message 126, vehicle control component 144 may receive real-time information obtained by PAAV 110 or other decentralized sources (i.e. sources other than from operators of the temporary zone) to supplement or replace information indicated by pathway article message 126.

In some examples, vehicle control component 144 may collect, in response to receiving an indication of a temporary zone, environmental information related to navigational characteristics of the temporary zone. Environmental information related to navigational characteristics of the temporary zone may include any data received from sensors, external devices, or any other source that may assist in classifying the temporary zone. Vehicle control component 144 may receive data regarding navigational characteristics of the temporary zone. Vehicle control component 144 may receive data from a variety of inputs. In some examples, vehicle control component 144 may receive data indicated by pathway article message 126, as described above. For example, vehicle control component 144 may receive an operating rule set or threshold level of autonomous operation indicated by pathway article message 126.

In some examples, vehicle control component 144 receives data from sensors of PAAV 110. For example, vehicle control component 144 may receive images of navigational characteristics of the temporary zone from image capture devices 102. Data from sensors of PAAV 110 may include, but are not limited to, weather conditions, traffic data, GPS data, road conditions, pathway articles such as markers 111, and the like. Sensors from which data may be collected may include, but are not limited to, temperature sensors, GPS devices, LiDAR, and RADAR.

In some examples, vehicle control component 144 may be configured to receive an image that includes an indication of the temporary zone and classify the temporary zone based on at least one of the image of the indication of the temporary zone and navigational characteristics of the temporary zone represented in the image. For example, the image of the indication of the temporary zone may be an image of a construction sign, traffic cone, or other object that indicates a temporary zone. The image of the temporary zone may represent navigational characteristics of the temporary zone. For example, a traffic cone may indicate a temporary lane of the temporary zone.

In some examples, vehicle control component 144 receives data from an external device. For example, computing device 134 may include a datastore that includes navigational characteristics of the temporary zone, such as traffic pattern changes, presence of workers, lane width modification, curves, and shifts, road surface quality, and the like. In some examples, computing device 134 may include a datastore that includes navigational conditions of the temporary zone, such as location data, congestion data, vehicle behavior variability, speed, lane departure, acceleration data, brake actuation data, and the like. Such navigational characteristics and conditions may be official data, such as supplied by operators having control of the temporary zone or may be crowd sourced data, such as supplied by users travelling through the temporary zone.

Vehicle control component 144 may receive data from various inputs and determine a navigational complexity of the temporary zone based on the received data. The navigational complexity of the temporary zone may represent the sensory and computational complexity of the navigational characteristics of the temporary zone. For example, the navigational complexity of the temporary zone may provide PAAV 110 with information sufficient to determine whether PAAV 110 may navigate the temporary zone in a given mode of autonomous operation.

In some examples, the classification of the temporary zone may correspond to a level of autonomous operation of PAAV 110. For example, vehicle control component 144 may receive data from various sensors and determine navigational characteristics of the temporary zone of pathway 106 based on the received data. Vehicle control component 144 may classify the navigational characteristics of temporary zone and determine a level of autonomous operation that can safely handle the navigational characteristics. For example, if the navigational characteristics of a temporary zone require lateral and longitudinal motion control of PAAV 110, vehicle control component 144 may classify the temporary zone as corresponding to level 1 driving automation as defined by J3016. The level of autonomous operation of PAAV 110 may be associated with various dynamic driving tasks that involve varying levels of complexity. For example, dynamic driving tasks may include longitudinal motion control such as acceleration, braking, and forward collision avoidance; lateral motion control such as steering and free collision; and the like. In some examples, the level of autonomous operation may be associated with various advanced driver assistant system (ADAS) functions, such as adaptive cruise control, adaptive light control, automatic braking, automatic parking, blind spot detection, collision avoidance systems, GPS navigation, driver drowsiness detection, hill descent control, intelligent speed adaptation, night vision, lane departure warning, forward collision warning, and the like.

Computing device 116 includes vehicle control component 144 to control autonomous operation of PAAV 110. Vehicle control component 144 may be configured to receive information indicated by pathway article message 126. In some examples, vehicle control component 144 may receive an operating rule set that describes navigational characteristics of the temporary zone. For example, in response to interpretation component 118 outputting a request for the operating rule set, vehicle control component 144 may receive the operating rule set. In some examples, vehicle control component 144 may receive a classification of the temporary zone, such as a level or threshold level of autonomous operation for the temporary zone.

Vehicle control component 144 may be configured to modify, based on the information indicated by pathway article message 126, a mode of autonomous operation of PAAV 110 while operating within the temporary zone. A mode of autonomous operation may represent a set of autonomous or semi-autonomous responses of PAAV 110 to navigational stimuli received by PAAV 110. Navigational stimuli may include any sensory input that may be used for navigation. For example, PAAV 110 may detect a navigational stimulus from a sensor, such as a lane marker from one of image capture devices 102. Based on characteristics of the lane marker, such as a position of the lane marker with respect to PAAV 110, PAAV 110 may perform a first operation, such as notifying a driver that the lane marker is near, in a first mode of autonomous operation and perform a second operation, such as avoiding the lane marker, in a second mode of operation. As such, a change in a mode of autonomous operation may include changing a response of PAAV 110 to the navigational stimulus, such as through different operating rules or different levels of autonomous operation.

In some examples, such as examples where pathway article message 126 indicates an operating rule set for the temporary zone, vehicle control component 144 may be configured to modify the mode of autonomous operation by updating a current operating rule set with the operating rule set indicated by pathway article message 126. For example, vehicle control component 144 may direct operations of PAAV 110, such as responses of PAAV 110 to navigational stimuli, within the temporary zone according to the updated operating rule set. The updated operating rule set may provide vehicle control component 144 with supplemental or replacement operating rules that may be directed toward localized conditions in the temporary zone.

In some examples, vehicle control component 144 may be configured to modify the mode of autonomous operation by changing a level of autonomous operation to the level of or within the threshold of autonomous operation indicated by pathway article message 126. For example, if pathway article message 126 indicates a maximum level of autonomous operation permitted for PAAV 110 within the temporary zone and vehicle control component 144 is operating PAAV 110 above the maximum level of autonomous operation permitted for PAAV 110, vehicle control component 144 may reduce the level of autonomous operation of the PAAV to the maximum level indicated by pathway article message 126. As another example, if pathway article message 126 indicates a minimum level of autonomous operation permitted for PAAV 110 within the temporary zone and vehicle control component 144 is operating PAAV 110 below the minimum level of autonomous operation permitted for PAAV 110, vehicle control component 144 may determine PAAV 110 does not have a level of autonomous vehicle operation capability to meet the minimum level indicated by pathway article message 126 and output an alert to a driver to begin non-autonomous operation of PAAV 110.

Vehicle control component 144 may include, for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed because of these changes. In some examples, the computing device initiates the determined adjustment for one or more functions of PAAV 110 based on the second information in conjunction with a human operator that alters one or more functions of PAAV 110 based on the first information.

In some examples, the mode of autonomous vehicle operation of PAAV 110 is based on at least one of capabilities of one or more sensors of PAAV 110 and capabilities of navigational software of the PAAV. For example, the one or more sensors of PAAV 110 and capabilities of navigational software of PAAV may at least partly determine the navigational capabilities of vehicle control component 144 by determining the type and/or complexity of sensory information from pathway 106 and/or the complexity of navigational decisions based on the sensory information. For example, the capabilities of the one or more sensors and the navigational software include at least one of a minimum version of the navigational software and minimum operating requirements of the one or more sensors. In some examples, the level of autonomous operation corresponds to an industry standard, such as a level of driving autonomation as defined in Society of Automotive Engineers (SAE) International J3016, US National Highway Traffic Safety Administration (NHTSA), and German Federal Highway Research Institute (BASt).

The pathway article of this disclosure is just one piece of redundant information that computing device 116, or a human operator, may consider when operating a vehicle. Other information may include information from other sensors, such as radar or ultrasound distance sensors, lane markings on the vehicle pathway captured from image capture devices 102, information from GPS, and the like. Computing device 116 may consider the various inputs (p) and consider each with a weighting value, such as in a decision equation, as local information to improve the decision process. One possible decision equation may include:

D=w₁*pₜ+w₂*p₂+ . . . wₙ*pₙ+w_{PA}*p_{PA}

where the weights (w₁-wₙ) may be a function of the information received from pathway article 108 (p_{PA}). In the example of a construction zone, an enhanced sign may indicate a lane shift from the construction zone. Therefore, computing device 116 may de-prioritize signals from lane marking detection systems when operating the vehicle in the construction zone.

In some examples, PAAV 110 may be a test vehicle that may determine one or more navigational characteristics of vehicle pathway 106 and may include additional sensors as well as components to communicate to a datastore that includes information related to navigation of the temporary zone. As a test vehicle, PAAV 110 may be autonomous, remotely controlled, semi-autonomous or manually controlled. One example application may be to determine a change in vehicle pathway 106 near a construction zone. Once the construction zone workers mark the change with barriers, traffic cones or similar markings, PAAV 110 may traverse the changed pathway to determine characteristics of the pathway. Some examples may include a lane shift, closed lanes, detour to an alternate route and similar changes. The computing device onboard the test device, such as computing device 116 onboard PAAV 110, may assemble the characteristics of the vehicle pathway into data that contains the characteristics, or attributes, of the vehicle pathway.

In the example of FIG. 1, computing device 134 includes a policy control system 130. In one example approach, policy control system 130 executes in external computing device 134 and responds to requests from computing device 116 for policies to use in response to diminished or modified sensor capabilities as measured by sensor capability assessment system 128. In some example approaches, policy control system 130 may include information provided by one or more pathway article messages 126. In some examples, policy control system 130 is configured to store and maintain information related to navigation of the temporary zone. For example, policy control system 130 may include one or more datastores configured to store policies, received from one or more parties, on responding to changes in sensor capabilities. Policy control system 130 may be configured to receive a request for a policy indicated by pathway article message 126, look up the policy indicated by pathway article message 126, and output the policy indicated by pathway article message 126 to vehicle control component 144 for use with the capabilities measured by sensor capability assessment system 128.

According to aspects of this disclosure, in operation, interpretation component 118 may receive an image of pathway article message 126 of pathway article 108 via image capture circuitry 103 and process the image to obtain a pathway article message from pathway article message 126. Interpretation component 118 may interpret the pathway article message, such as by looking up a code associated with the pathway article message from a pathway article message 126 in a table, to obtain information related to navigation of a temporary zone.

In some examples, such as examples where pathway article message 126 indicates a start of the temporary zone, interpretation component 118 may determine that pathway article message 126 indicates the start of the temporary zone and send the determination to vehicle control component 144. In response to receiving the determination of the start of the temporary zone, vehicle control component 144 may receive real-time sensory information for the temporary zone and determine a classification of the temporary zone based, at least in part, on the real-time sensory information. For example, interpretation component 118 may receive images of navigational characteristics of the temporary zone, such as from image capture devices 102, and provide to the vehicle control component 144 a classification level of the temporary zone based on the images of the navigational characteristics of the temporary zone. As another example, vehicle control component 144 may discern and prioritize data from different sensory sources and shift a sensory focus to more local navigation techniques.

In some examples, such as examples where pathway article message 126 indicates a classification of the temporary zone, interpretation component 118 may determine that pathway article message 126 indicates a classification of the temporary zone and send an indication of the classification to vehicle control component 144. In response to receiving the indication of the classification of the temporary zone, vehicle control component 144 may modify a mode of autonomous operation of PAAV 110 based on the classification of the temporary zone. For example, vehicle control component 144 may change a level of autonomous operation of PAAV 110 to a level of autonomous operation that corresponds to the classification of the temporary zone.

In some examples, such as examples where pathway article message 126 indicates an operating rule set for the temporary zone, interpretation component 118 may determine that pathway article message 126 indicates the operating rule set of the temporary zone and send a request for the operating rule set to computing device 134. In response to receiving the requested operating rule set, vehicle control component 144 may modify the mode of autonomous operation of PAAV 110 based on the operating rule set. For example, vehicle control component 144 may update (i.e. supplement or replace) an operating rule set of PAAV 110 with the operating rule set that corresponds to the temporary zone.

By using information related to navigation of the temporary zone to direct autonomous operation of PAAV 110 through the temporary zone, computing device 116 may more accurately, safely, and/or effectively navigate the temporary zone. For example, computing device 116 may direct autonomous operation of PAAV 110 using an operating rule set that customized to the temporary zone and updated in real-time based on changes to the temporary zone. As another example, computing device 116 may direct autonomous operation of PAAV 110 at a level of autonomous operation that is appropriate for the navigational characteristics of the temporary zone.

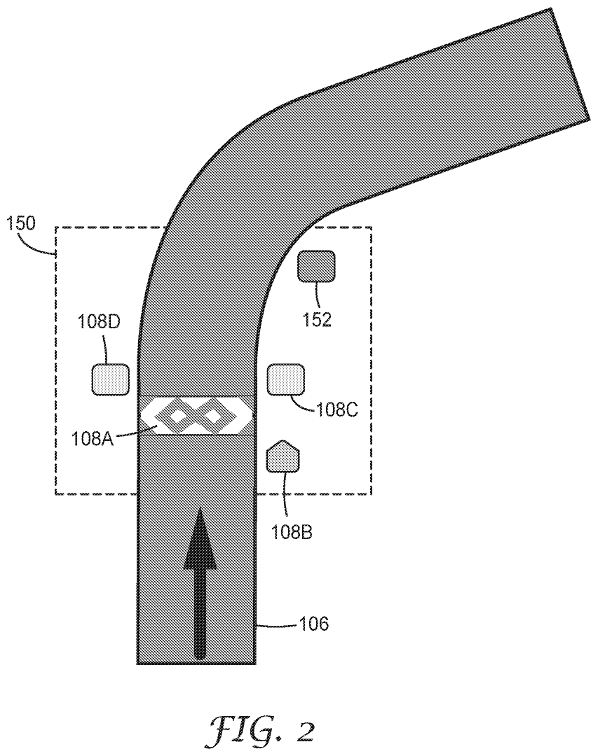

FIG. 2 is a block diagram illustrating a sensor capability testing zone, in accordance with techniques of this disclosure. In the example shown in FIG. 2, sensor capability testing zone 150 includes one or more pathway articles 108, including a pavement marking 108A, a sign 108B, a radar object 108C, a LiDAR object 108D and a road side unit. Sign 108B and pavement marking 108A are like the sign 108B and the pavement marking 108A shown in FIG. 1 but sensor capability testing zone 150 as illustrated in FIG. 2 further includes radar object 108C for radar calibration, LiDAR object 108D for LiDAR calibration, and, in some example approaches, a road side unit 152. In this example, sensor capability assessment system 128 operates as a gate keeper prior to vehicles entering a freeway. Once the sensor capabilities are determined, then a variety of policy decisions can be made. In some such examples, the policies are based the knowledge and interests of outside parties.

In one example approach, road side unit 152 operates to either transmit expected readings from a set of a priori known algorithms, or to actively modify vehicle policy based on both current laws or rules and the vehicle's ability to read the calibration objects. In one example approach, the road side unit includes external computing device 134. In one such approach, road side unit 152 includes sensor capability assessment system 128 such that road side unit 152 can receive sensor information from a PAAV 110, determine if the sensor data is as expected, and provides to PAAV 110 a sensor assessment based on the sensor information received from the PAAV 110. In one such approach, policies stored in PAAV 110 received the sensor assessments from road side unit 152 and apply the stored Policies to determine how to respond to the sensor assessment. In some example approaches, PAAV 110 communicates with road side unit 152 via a wireless protocol. In some such example approaches, the wireless protocol is a transportation oriented wireless communication channels such as v2x or Dedicated Short-Range Communications (DSRC). In other such example embodiments, wireless communications channels that are not transportation specific are used.

In one example approach, policies that determine PAAV operation based on the assessment of sensor capabilities by sensor capability assessment system 128 are set by a transportation authority based on factors such as the environment or traffic control. In other example approaches, policies that determine PAAV operation based on the assessment of sensor capabilities by sensor capability assessment system 128 are set by other parties, such as, for example, by insurance companies. In one approach, for example, insurance companies establish policy models based on experience on pathways 106. The policy models establish one or more policies for responding to diminished sensor capabilities.

In other example approaches, policies that determine PAAV operation based on the assessment of sensor capabilities by sensor capability assessment system 128 are set by a car manufacturer or by the driver of a PAAV.

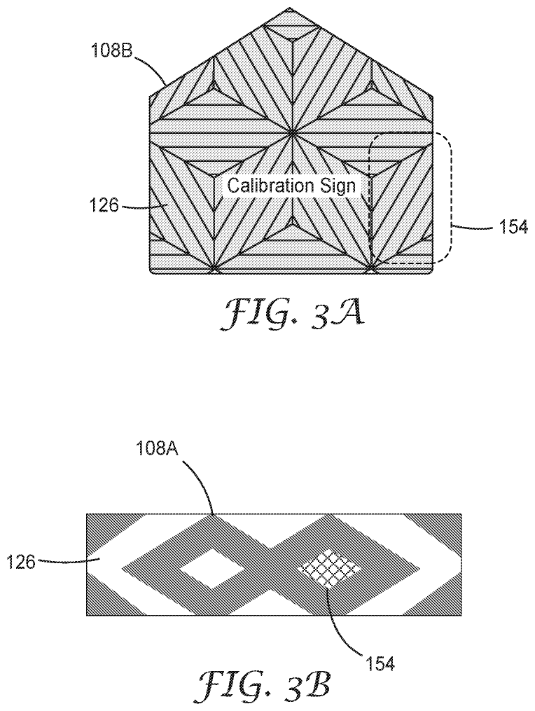

FIGS. 3A and 3B are block diagrams illustrating pathway articles that may be used in a sensor capability testing zone, in accordance with techniques of this disclosure. In the example shown in FIG. 3A, sign 108B includes one or more pathway messages 126, including one or more sensor accuracy measurement features 154 used by sensor capability assessment system 128 to assess operation of one or more of the sensors of PAAV 110.

In the example shown in FIG. 3B, pavement marker 108A includes one or more pathway messages 126, including one or more sensor accuracy measurement features 154 used by sensor capability assessment system 128 to assess operation of one or more of the sensors of PAAV 110.

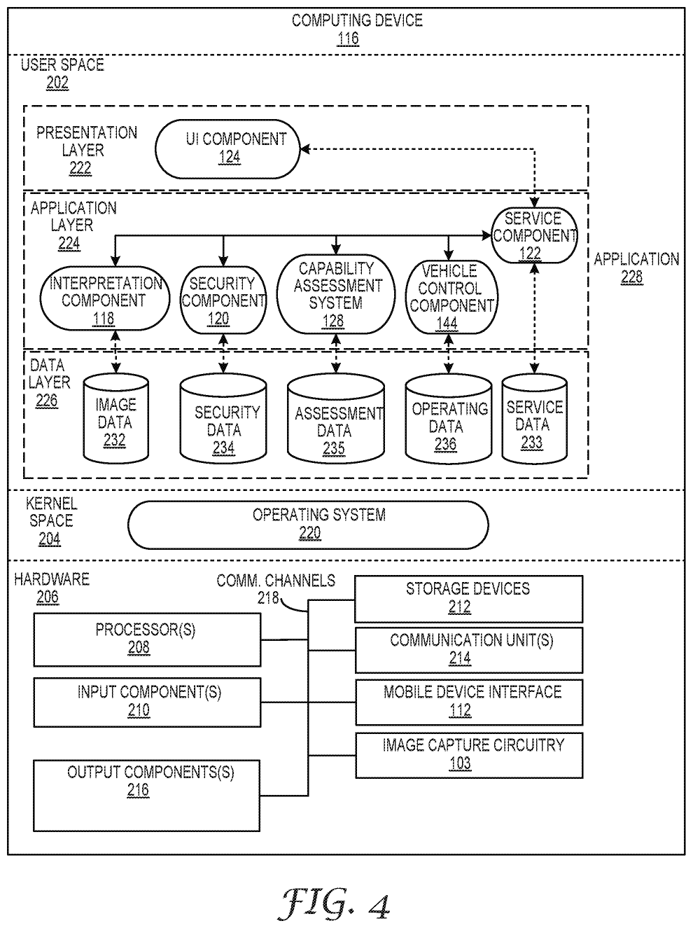

FIG. 4 is a block diagram illustrating an example computing device, in accordance with one or more aspects of the present disclosure. FIG. 4 illustrates only one example of a computing device. Many other examples of computing device 116 may be used in other instances and may include a subset of the components included in example computing device 116 or may include additional components not shown example computing device 116 in FIG. 4.

In some examples, computing device 116 may be a server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110, depicted in FIG. 1. In other examples, computing device 116 may also be part of a system or device that determines one or more operating rule sets for a temporary zone and may correspond to computing device 134 depicted in FIG. 1.

As shown in the example of FIG. 4, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202.

As shown in FIG. 4, hardware 206 includes one or more processors 208, input components 210, storage devices 212, communication units 214, output components 216, mobile device interface 112, and image capture circuitry 103. Processors 208, input components 210, storage devices 212, communication units 214, output components 216, mobile device interface 112, and image capture circuitry 103 may each be interconnected by one or more communication channels 218. Communication channels 218 may interconnect each of the components 102, 103, 104, 112, 208, 210, 212, 214, 216 and other components for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes information regarding a vehicle pathway, such as an operating rule set for navigating the vehicle pathway or a level of autonomous control of the vehicle pathway. In examples where computing device 116 is part of a vehicle, such as PAAV 110 depicted in FIG. 1, communication units 214 may receive information about a pathway article 108 from an image capture device 102 or 104, as described in relation to FIG. 1. In other examples, such as examples where computing device 116 is part of a system or device that determines one or more operating rule sets of a temporary zone, communication units 214 may receive data from a test vehicle, handheld device or other means that may gather data that indicates the navigational characteristics of a vehicle pathway, as described above in FIG. 1 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116 but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Output components 216 may also include vehicle control component 144, in examples where computing device 116 is onboard a PAAV. Vehicle control component 144 has the same functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 4, application 228 executes in user space 202 of computing device 116. Application 228 may be logically divided into presentation layer 222, application layer 224, and data layer 226. Presentation layer 222 may include user interface (UI) component 124, which generates and renders user interfaces of application 228. Application 228 may include, but is not limited to: UI component 124, interpretation component 118, security component 120, and one or more service components 122. For instance, application layer 224 may interpretation component 118, service component 122, and security component 120. Presentation layer 222 may include UI component 124.

Data layer 226 may include one or more datastores. A datastore may store data in structure or unstructured form. Example datastores may be any one or more of a relational database management system, online analytical processing database, table, or any other suitable structure for storing data.

Security data 234 may include data specifying one or more validation functions and/or validation configurations. Service data 233 may include any data to provide and/or resulting from providing a service of service component 122. For instance, service data may include information about pathway articles (e.g., security specifications), user information, operating rule sets, levels of autonomous operation, or any other information transmitted between one or more components of computing device 116. Image data 232 may include one or more images of pathway article message 126 that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats. Assessment data 235 may include data for assessing sensor capabilities. Operating data 236 may include instructions for operating PAAV 110. Operating data may include one or more operating rule sets, one or more operating protocols for various levels of autonomous operation, one or more policies for determining movement of PAAV 110 as a function of the PAAV's sensing capability and the like.

In the example of FIG. 4, one or more of communication units 214 may receive, from an image capture device, an image of a pathway article that includes a code indicative of a temporary zone embedded thereon, such as pathway article message 126 in FIG. 1. In some examples, UI component 124 or any one or more components of application layer 224 may receive the image of pathway article message 126 and store the image in image data 232.

In response to receiving the image of pathway article message 126, interpretation component 118 may process the image of pathway article message 126 to obtain the pathway article message. Pathway article message 126 may indicate information related to navigation of the temporary zone. Interpretation component 118 may interpret pathway article message 126 to obtain the information related to navigation of the temporary zone, such as by using decoding information from image data 232. Interpretation component 118 may provide the information related to navigation of the temporary zone to vehicle control component 144. Computing device 116 may combine this information with other information from other sensors, such as image capture devices, GPS information, information from network 114 and similar information to adjust the speed, suspension or other functions of the vehicle through vehicle control component 144.

In some examples, pathway article message 126 may indicate a classification of the temporary zone. The classification of the temporary zone may represent the complexity of navigational characteristics of the temporary zone. Interpretation component 118 may determine the classification of the temporary zone based on pathway article message 126 and send an indication of the classification to vehicle control component 144. Vehicle control component 144 may determine a level of autonomous operation based on the classification of the temporary zone. For example, if the classification is associated with a particular level or threshold level of autonomous operation, such as a level of driving automation per SAE J3016, vehicle control component 144 may select a level of autonomous operation that matches the particular level or is within the particular threshold level of autonomous operation associated with the classification. As another example, if the classification is associated with particular navigational capabilities of a vehicle operating in the temporary zone, such as particular dynamic driving tasks, vehicle control component 144 may select a level of autonomous operation that meets or exceeds the particular navigational capabilities. For example, if PAAV 110 is capable of autonomous longitudinal motion control within a specified responsiveness threshold for the temporary zone, but not autonomous lateral motion control within a specified responsiveness threshold for the temporary zone, vehicle control component 144 may select a level of autonomous operation that includes autonomous longitudinal motion control, but not autonomous lateral motion control.

In some examples, pathway article message 126 may indicate a start of the temporary zone. Vehicle control component 144 may modify a mode of autonomous operation of PAAV 110 by selecting the determined level of autonomous operation and directing operations of PAAV 110 according to the selected level of autonomous operation while operating within the temporary zone. For example, vehicle control component 144 may reduce a level of autonomous operation of PAAV 110 for the duration of the temporary zone and assume a previous level of autonomous operation once PAAV 110 is out of the temporary zone.

In some examples, pathway article message 126 may indicate an operating rule set of the temporary zone. The operating rule set of the temporary rule zone may represent one or more rules for navigating the navigational characteristics of the temporary zone. Interpretation component 118 may determine the operating rule set of the temporary zone based on pathway article message 126 and send an indication of the operating rule set to vehicle control component 144. In response to receiving the indication of the operating rule set, vehicle control component 144 may select the operating rule set, such as from operating data 236.

Vehicle control component 144 may modify a mode of autonomous operation of PAAV 110 by selecting the determined operating rule set and directing operations of PAAV 110 according to the selected operating rule set while operating within the temporary zone. For example, vehicle control component 144 may operate PAAV 110 with the operating rule set for the temporary zone while in the temporary zone and may operate PAAV 110 with a previous operating rule set once PAAV 110 is no longer in the temporary zone.

While interpretation component 118 has been described as providing information, such as an indication of a classification or operation rule set, directly to vehicle control component 144, in some examples, interpretation component 118 may indirectly provide information to vehicle control component 144. For example, pathway article message 126 may be a link or other reference to an external device, such as computing device 134 of FIG. 1, that includes information related to navigation of the temporary zone. Interpretation component 118 may send a request for the information related to navigation of the temporary zone to computing device 134. In response, computing device 134 may send the requested information to vehicle control component 144. Vehicle control component 144 may receive dynamic information related to navigation of the temporary zone. In this way, pathway article message 126 may act as a pointer to a datastore entry and a reference for digitally-connected information regarding the temporary zone that enables specific, dynamic content delivery and improves decision making, safety, and efficiency.

In some examples, the pathway articles of this disclosure may include one or more security elements to help determine if the pathway article is counterfeit. Security component 120 may determine whether pathway article, such as pathway article 108, is counterfeit based at least in part on determining whether the code, such as pathway article message 126, is valid for at least one security element. As described in relation to FIG. 1 security component 120 may include one or more validation functions and/or one or more validation conditions on which the construction of pathway article 108 is based. In other examples a pathway article may include one or more security elements. In FIG. 4, security component 120 determines, using a validation function based on the validation condition in security data 234, whether the pathway article depicted in FIG. 1 is counterfeit. Security component 120, based on determining that the security elements satisfy the validation configuration, generate data that indicates pathway article 108 is authentic (e.g., not a counterfeit). If security elements and the article message in pathway article 108 did not satisfy the validation criteria, security component 120 may generate data that indicates pathway article 108 is not authentic (e.g., counterfeit) or that the pathway article is not being read correctly.

Service component 122 may perform one or more operations based on the data generated by security component 120 that indicates whether the pathway article is a counterfeit. Service component 122 may, for example, query service data 233 to retrieve a list of recipients for sending a notification or store information that indicates details of the image of the pathway article (e.g., object to which pathway article is attached, image itself, metadata of image (e.g., time, date, location, etc.)). In response to, for example, determining that PAAV 110 does not have a level of autonomous vehicle operation capability to meet a minimum level, service component 122 may send data to UI component 124 that causes UI component 124 to generate an alert to a driver to begin non-autonomous operation of PAAV 110. UI component 124 may send data to an output component of output components 216 that causes the output component to display the alert.

By using information related to navigation of the temporary zone to direct autonomous operation of PAAV 110 through the temporary zone, computing device 116 may more accurately, safely, and/or effectively navigate the temporary zone. For example, computing device 116 may direct autonomous operation of PAAV 110 using an operating rule set that customized to the temporary zone and updated in real-time based on changes to the temporary zone. As another example, computing device 116 may direct autonomous operation of PAAV 110 at a level of autonomous operation that is appropriate for the navigational characteristics of the temporary zone.

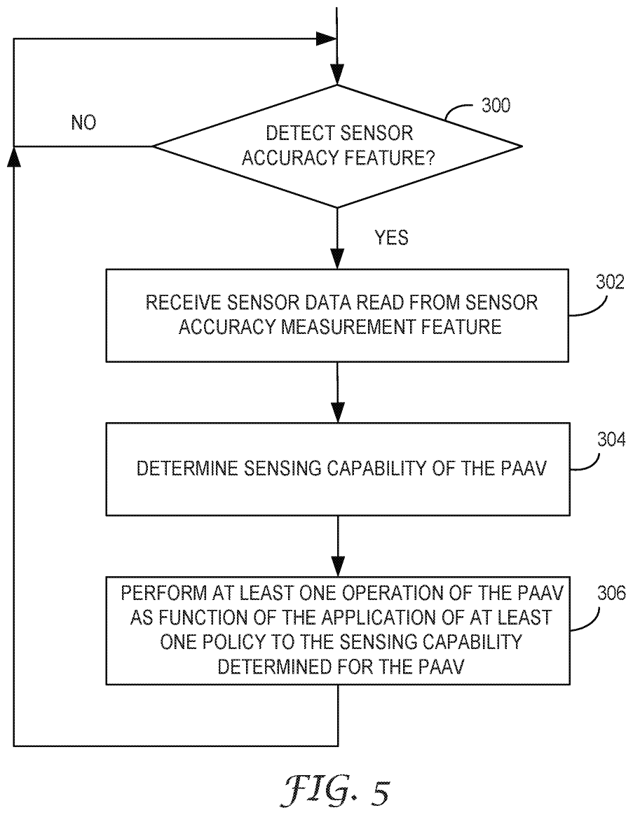

FIG. 5 is a flow diagram illustrating example operation of a computing device for directing operation of a pathway-article assisted vehicle, in accordance with techniques of this disclosure. As noted above, in some example approaches, PAAV 110 includes a sensor capability assessment system 128 used to assess the current performance of its sensors. This assessment may happen via an a priori agreement of sensed features, or via those same features but, with an active confirmation component.

In the flowchart of FIG. 5, one or more sensors of PAAV 110 check pathway articles along a pathway 106 to determine if any of the pathway articles 108 or 111 include a sensor accuracy measurement feature 154 (300). If a sensor finds a pathway article that includes a sensor accuracy measurement feature 154, the sensor reads data from the sensor accuracy measurement feature. In some examples, the data is encoded as an image on the pathway article. In some examples, the data is encoded using electromagnetic or other means.

Computing device 116 receives the data read from sensor accuracy measurement feature 154 (302). Computing device 116 uses the data read from sensor accuracy measurement feature 154 to determine a sensing capability for the PAAV 110 (304) and performs at least one operation of the PAAV 110 as a function of the at least one policy applied to the sensing capability determined for the PAAV 110 (306).

As noted above, it can be advantageous to permit operation of PAAVs even if they have degraded sensing capabilities. In one example approach, therefore, autonomous vehicle navigation systems adapt to changes in sensor capabilities. In some examples, the current sensing capabilities of the vehicle are a function of the capabilities of the vehicle's navigation systems, including the sensors and the computational elements that work with the sensors. In other example approaches, external factors, such as snow, rain or other environmental conditions or, for example, a cybercriminal attack, contribute to the measure of a vehicle's sensor capabilities. In some example approaches, therefore, vehicles equipped with sensor capability determination systems, or which have access to such systems, may operate over a wider variety of conditions, even with impaired or degraded sensor suites.

Accordingly, in some example approaches, PAAV 110 performs techniques to change the operation of PAAV 110 so that it can continue to operate safely despite the diminished sensing capability. In other example approaches, PAAV 110 modifies operation of sensors having a lower confidence level to increase the system's confidence in the information received from the sensor. For example, in some example approaches, PAAV 110 recalibrates the problem sensor. In other example approaches, PAAV 110 calibrates the problem sensor based on the expected data to make it operate better in the current environment. In others, both calibration and adaptation are used.

Vehicles equipped with sensor capability determination systems, or which have access to such systems, are also capable of self-healing. In one example approach, for instance, if a vehicle control system becomes aware through its sensor capability determination system that a sensor is inoperative or degraded, it takes steps to bolster ways of obtaining the necessary information from pathway articles. In one such example approach, the vehicle control system recalibrates the problem sensor. In some such example approaches, this recalibration is done based on vehicle standard recalibration procedures.

In one such example approach, the vehicle control system recalibrates the problem sensor. In some such example approaches, this recalibration is done based on vehicle standard recalibration procedures. In some example approaches, this recalibration is done based on a comparison of expected features of a pathway message versus features as read from the pathway article. One approach is to compute a point spread function to correct for blurring in an image captured by a camera, or to compensate for missing pixels. Steps to sharpen or otherwise modify images captured by the camera may also be used.

In other example approaches, the sensor capability determination system assigns a confidence level to each sensor tested and the vehicle changes the weights applied to sensor contributions to deemphasize sensors with lower confidence levels and to emphasize sensors with higher confidence levels. In yet other example approaches, the vehicle includes sensors of similar or other modalities that provide an alternate mechanism for acquiring the same information. For instance, if an imaging sensor is impaired, information normally received via the imaging sensor may be retrieved via the LiDAR sensor. In some such example approaches, the LiDAR sensor is recalibrated to enhance its ability to sense the additional information. For instance, the LiDAR sensor may be recalibrated based on data read from a pathway article.

Sensor assessment systems such as sensor capability assessment system 128 increase vehicle safety and may further be used to establish policies for the safe operation of vehicles across a variety of conditions and despite degraded sensor capabilities. Such a system can further be used to operate as a standard calibration/validation tool that may be used by other equipment manufacturers and by departments of transportation to set policies about the level of automation which may be used given current sensing capabilities. Further, the data collected by this system may further be collected and sold to third parties.

In one example approach, when computing device 116 uses the data read from sensor accuracy measurement feature 154 to determine a sensing capability for the PAAV 110, it generates an assessment score for each respective sensor.

In one example approach, when computing device 116 uses the data read from sensor accuracy measurement feature 154 to determine a sensing capability for the PAAV 110, it generates a confidence score for each respective sensor, the confidence score reflecting perceived effectiveness of the respective sensor.

In one example approach, the sensors include a first sensor and a second sensor. The first sensor captures sensor data generated by sensing, with the first sensor, at least one of the sensor accuracy measurement features deployed along the pathway. The second sensor captures sensor data generated by sensing, with the second sensor, at least one of the sensor accuracy measurement features deployed along the pathway. Computing device 116 uses the data read from sensor accuracy measurement feature 154 generate a combined confidence score for the first and second sensors, the combined confidence score indicating perceived effectiveness of operation of the first and second sensors in combination. In one such example approach, generating a combined confidence score for the first and second sensors includes calculating a sensor accuracy for the first sensor and calculating a sensor accuracy for the second sensor, and calculating the combined confidence score for the first and second sensors as a function of a weighted version of the sensor accuracy calculated for the first sensor and a weighted version of the sensor accuracy calculated for the second sensor. In one example approach, performing at least one operation of the PAAV as a function of at least one policy applied to the sensing capability determined for the PAAV includes applying the at least one policy to the combined confidence score for the first and second sensors.

In one example approach, computing device 116 directs the sensors to sense the one or more sensor accuracy measurement features on the pathway. In another example approach, computing device 116 directs the sensors to sense the one or more sensor accuracy measurement features on the pathway based on location.

In one example approach, the at least one policy includes one or more policies established by a first party and one or more policies established by a second party.

In one example approach, computing device 116 selects policies to apply based on a hierarchy of policies.

In one example approach, PAAV 110 has a current level of automation. Performing at least one operation of the PAAV as a function of at least one policy applied to the sensing capability determined for the PAAV includes determining, based on the determined sensing capability of the PAAV and the at least one policy, whether the PAAV can operate at the current level of automation, and downgrading the PAAV to a lower level of automation if the PAAV cannot operate at its current level of automation.

In one example approach, computing device 116 determines a sensor accuracy for one or more of the respective sensors based on the captured sensor data received from each respective sensor, compares sensor accuracies determined for each respective sensor to sensor accuracies determined for similar sensors in other PAAVs based on sensing the same one or more sensor accuracy measurement features and adjusts the sensing capability determined for the PAAV based on the comparison.

In one example approach, computing device 116 determines a sensor accuracy for one or more of the respective sensors based on the captured sensor data received from each respective sensor, compares sensor accuracies determined for each respective sensor to sensor accuracies determined for similar sensors in other PAAVs based on sensing the same one or more sensor accuracy measurement features and reports sensor accuracy measurement features on the pathway that consistently generate lower sensor accuracy determinations.

In one example approach, computing device 116 compares the assessment score for each respective sensor to assessment scores of similar sensors in other PAAVs based on sensing the same one or more sensor accuracy measurement features and reports sensor accuracy measurement features on the pathway that consistently generate lower assessment scores.

In one example approach, computing device 116 receives, from a road side unit 152, the expected sensor data expected to be captured by the respective sensor when sensing at least one of the one or more sensor accuracy measurement features on the pathway.

In one example approach, computing device 116 receives, from a pathway article or from a road side unit 152, an indication of upcoming sensor accuracy measurement features on the pathway and directs, in response to the indication, the one or more sensors to sense the one or more sensor accuracy measurement features on the pathway.

In one example approach, system 100 includes a policy datastore, wherein the policy datastore includes the at least one policy, and wherein the policy datastore includes a computing device that receives policies, stores them in the datastore and provides them to the computing device in response to queries from computing device 116.

In some examples, PAAV 110 includes all or part of computing device 116. In other examples, road side unit 152 includes all or part of computing device 116. In yet other examples, computing device 116 is distributed across PAAV 110 and road side unit 152.

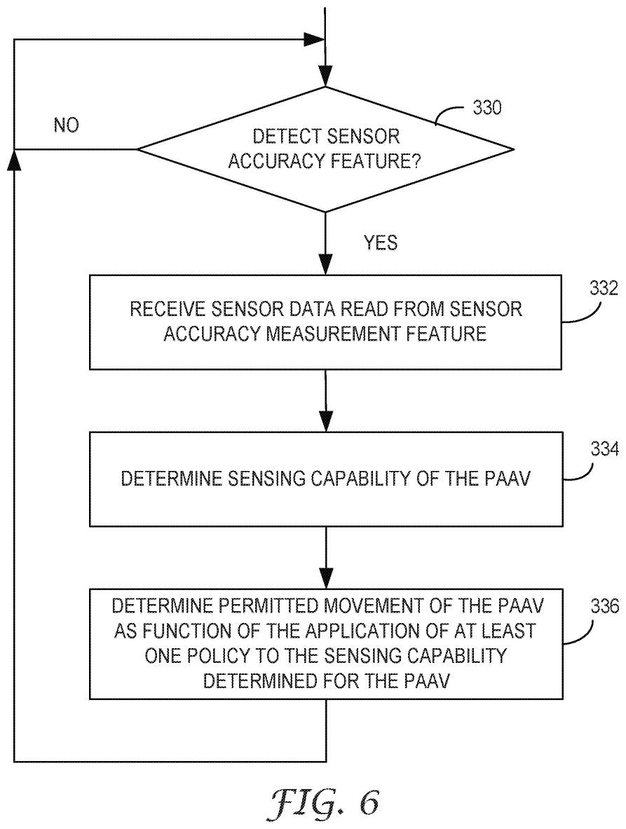

FIG. 6 is a flow diagram illustrating example operation of a computing device for determining permitted movement of a pathway-article assisted vehicle, in accordance with techniques of this disclosure. In the flowchart of FIG. 6, one or more sensors of PAAV 110 check pathway articles along a pathway 106 to determine if any of the pathway articles 108 or 111 include a sensor accuracy measurement feature 154 (330). If a sensor finds a pathway article that includes a sensor accuracy measurement feature 154, the sensor reads data from the sensor accuracy measurement feature. In some examples, the data is encoded as an image on the pathway article. In some examples, the data is encoded using electromagnetic or other means.

Computing device 116 receives the data read from sensor accuracy measurement feature 154 (332). Computing device 116 uses the data read from sensor accuracy measurement feature 154 to determine a sensing capability for the PAAV 110 (334) and determines permitted movement of the PAAV 110 as a function of the at least one policy applied to the sensing capability determined for the PAAV 110 (336).

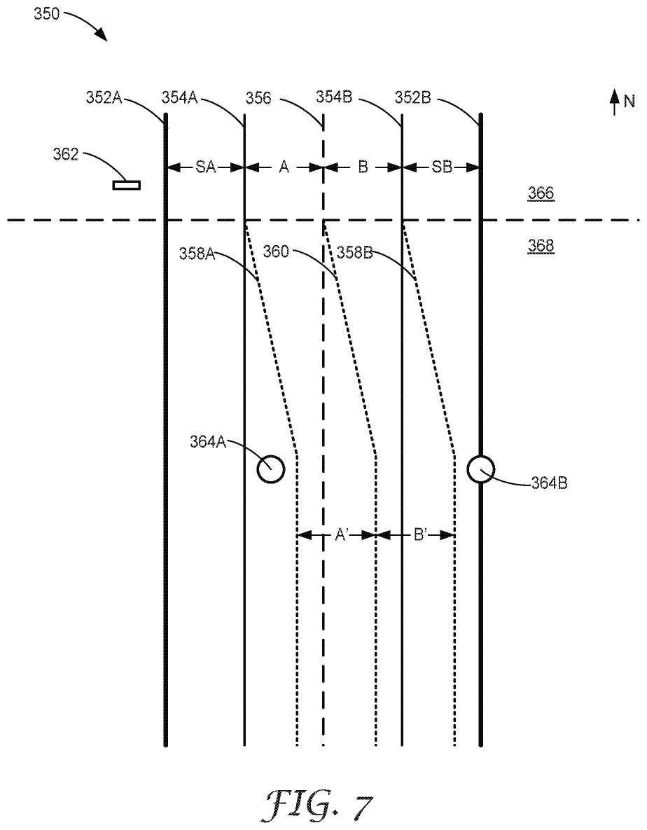

FIG. 7 is a diagram of an example roadway 350 that may be navigated by a PAAV as described herein. FIG. 7 will be described with reference to PAAV 110 of FIG. 1. In one example approach, roadway 350 includes a regular zone 366 (i.e. a non-temporary zone) and a temporary zone 368. Regular zone 366 of roadway 350 includes a first shoulder SA formed by a first roadway edge 352A and a first lane edge 354A, a first lane A formed by first lane edge 354A and a divider 356, a second lane B formed by divider 356 and a second lane edge 354B, and a second shoulder formed by second lane edge 354B and a second roadway edge 352B.

In the example of FIG. 7, temporary zone 368 is indicated by a pathway article 362 with a code embodied thereon, such as pathway article 108 or pathway article 111 of FIG. 1. Temporary zone 368 of roadway 350 includes a first temporary lane A′ formed by a first temporary edge 358A and a temporary divider 360 and a second temporary lane B′ formed by temporary divider 360 and a second temporary edge 358B. The temporary zone includes marker 364A outside temporary lane A′ and marker 364B outside temporary lane B′.

In the example of FIG. 7, PAAV 110 (not shown) may encounter temporary zone 368 from regular zone 366. For example, PAAV 110 may be travelling south along roadway 350 in first lane A. Upon encountering pathway article 362, PAAV 110 may generate an image of the article message on pathway article 362. Computing device 116 may receive the image of the article message and process the image to obtain the article message.

In some examples, the article message may indicate a start of temporary zone 368. Computing device 116 may modify a mode of autonomous operation of PAAV 110 based on the indication of the start of temporary zone 368. For example, computing device 116 may collect data regarding temporary zone 368, such as presence and location of first and second temporary edges 358, presence and location of temporary divider 360, presence and location of markers 364, previous route of other vehicles travelling through temporary zone 368, and other navigational characteristics of temporary zone 368. Computing device 116 may determine a classification of temporary zone 368 based on the complexity of navigational characteristics of the temporary zone. For example, computing device 116 may predict capabilities of PAAV 110 required to autonomously navigate temporary zone 368, such as an ability of computing device 116 to differentiate between temporary edges 358 and lane edges 354 based on other context information. Computing device 116 may select a level of autonomous operation based on the classification of temporary zone 368 and direct operation of PAAV 110 based on the selected level of autonomous operation. For example, if computing device 116 predicts that it does not have the ability to safely differentiate between temporary edges 358 and lane edges 354, computing device 116 may select a level of autonomous operation that includes autonomous operation of longitudinal motion control, but manual operation of lateral motion control.

In some examples, the article message may indicate a classification of temporary zone 368. For example, the article message may indicate a standardized classification of temporary zone 368, such as a classification associated with lane shifts, indicator markers such as markers 364, and other features present in temporary zone 368 that may be common in other temporary zones. Computing device 116 may modify a mode of autonomous operation of PAAV 110 based on the classification of temporary zone 368. Computing device 116 of PAAV 110 may select a level of autonomous operation based on the classification of temporary zone 368. For example, computing device 116 may look up a level of autonomous operation for PAAV 110, such as in a datastore, that corresponds to the classification indicated by the article message and select the level of autonomous operation, such as level 1 of driving autonomy per SAE J3016. As another example, computing device 116 may determine that PAAV 110 does not have a level of autonomous operation capability to meet a minimum level of autonomous operation indicated by the article message.

In some examples, the article message may indicate an operating rule set of temporary zone 368. For example, the operating rule set may include operating rules for navigating various navigational characteristics of temporary zone 368, such as operating to the left of 364A, operating within temporary lane A′, replacing lane edges 354 with temporary edges 358 for lateral motion guidance, reducing speed, and the like. Computing device 116 may modify a mode of autonomous operation of PAAV 110 based on the operating rule set for temporary zone 368. In some examples, computing device 116 may obtain the operating rule set by looking up the operating rule set, such as in a datastore, based on the article message. For example, the operating rule set may be a standardized operating rule set or a set of standardized operating rules for navigational characteristics included in temporary zone 368. In some examples, computing device 116 may obtain the operating rule set from an external device such as road side unit 152. For example, the operating rule set may be unique to temporary zone 368 (e.g. stay 3 feet left of marker 364A) or subject to change based on changes to temporary zone 368 (e.g. higher speed limit when workers no longer present). Computing device 116 may direct operations of PAAV 110 according to the operating rule set for temporary zone 368. For example, computing device 116 may ignore lane edges 354 and lane divider 356 and operate within temporary edges 358 and temporary divider 360.

As noted above, as one or more sensors of PAAV 110 check pathway articles along a pathway 106, the sensors may come across pathway articles 108 or 111 that include a sensor accuracy measurement feature 154. If a sensor finds a pathway article that includes a sensor accuracy measurement feature 154, the sensor reads data from the sensor accuracy measurement feature. Computing device 116 receives the data read from sensor accuracy measurement feature 154 and uses the data read from sensor accuracy measurement feature 154 to determine a sensing capability for the PAAV 110. Computing device 116 performs at least one operation of the PAAV 110 as a function of the at least one policy applied to the sensing capability determined for the PAAV 110.

As noted above, computing device 116 may obtain the operating rule set by looking up the operating rule set, such as in a datastore, based on an article message. The operating rule set may be a standardized operating rule set or a set of standardized operating rules for navigational characteristics included in temporary zone 368.

In some examples, vehicle control component 144 receives one or more policies for performing actions based, at least in part, on the PAAV's determination of the sensing capability of one or more of its sensors. As noted above, the one or more policies may be stored as operating data in operating datastore 236. The one or more policies may be stored as a hierarchy of policies in operating datastore 236.

As noted above, an assessment of sensor capabilities relies, at least in part, on a comparison of the expected sensor capability to the sensor capability obtained by sensing the sensor accuracy measurement feature. In some example approaches, the expected sensing capability associated with a given sensor accuracy measurement feature is stored as operating data in operating datastore 236. In other example approaches, the expected sensing capability associated with a given sensor accuracy measurement feature is read from the pathway article containing sensor accuracy measurement feature. In yet another approach, the expected sensing capability associated with a given sensor accuracy measurement feature is retrieved from an external source as a function of a code associated with the sensor accuracy measurement feature.

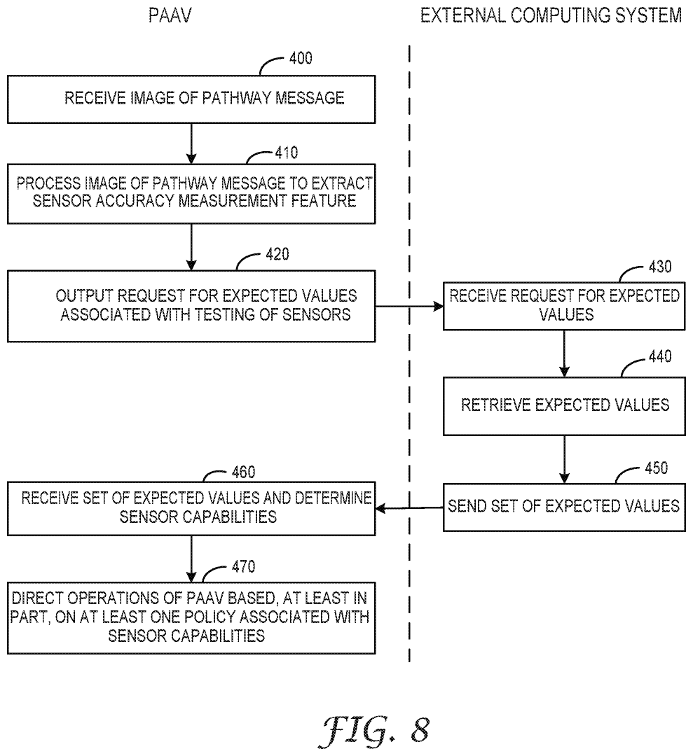

FIG. 8 is a flow diagram illustrating example operation of a computing device reacting to a sensor accuracy measurement feature, in accordance with one or more techniques of this disclosure. The techniques are described in terms of computing device 116 and computing device 134 of FIG. 1. However, the techniques may be performed by other computing devices.

In the example of FIG. 8, computing device 116 receives an image of a pathway article message 126 that includes a sensor accuracy measurement feature 154 (400). For example, computing device 116 may receive the image of pathway article message 126 from one of image capture devices 102 or from image capture device 104. Computing device 116 processes the image of pathway article message 126 to extract information corresponding to the sensor accuracy measurement feature (410). For example, computing device 116 may use one or more image processing techniques to identify information relating to sensor accuracy measurement feature 154 and use that information to determine the capability of image capture device 102. In some examples, the capability is a function of sensor sensitivity or accuracy. In some examples, the capability considers external factors. For instance, PAAV 110 may measure read range (i.e., the distance at which a sensor detects a sensor accuracy measurement feature) to determine how far a given sensor can sense features in the given environment (e.g., in rain or snow, or at night).

In one example approach, computing device 116 outputs, based on the sensor accuracy measurement feature, a request to a remote computing device, such as computing device 134 via network 114, for the expected values associated with testing the sensor capability of the one or more sensors being tested as part of the sensor accuracy measurement feature 154 (420). For example, sensor accuracy measurement feature 154 may have associated with it a location of a set of values expected when testing specific sensors. The location may be, for instance, a Uniform Resource Identifier. Computing device 116 may output the request for the set of values expected when testing specific sensors to computing device 134 based on the URL associated with the set of values.

Computing device 134 receives the request for the set of values expected when testing specific sensors (430). In response to receiving the receiving the request, computing device 134 retrieves the set of values (440). For example, the request for the set of values may include an identifier of the set of expected values. Computing device 134 may look up the set of expected values based on the identifier, such as in a datastore. Computing device 134 sends the set of values expected to computing device 116 (450).

Computing device 116 receives the set of expected values and determines sensor capabilities at least in part based on the sensor capabilities as sensed and the expected sensor values (460). Computing device 116 then determines, as a function of the sensor capabilities and at least one policy for operating based on sensor capability operations of PAAV 110 in the current pathway environment (470).

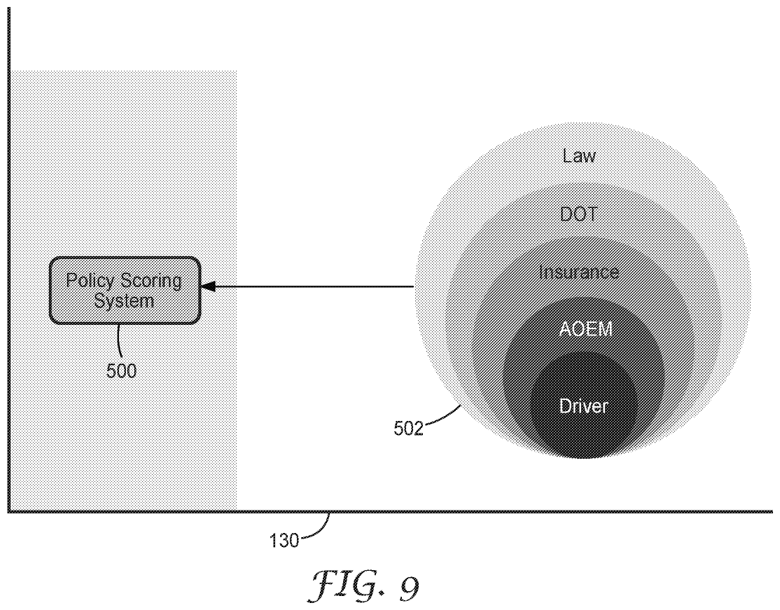

As noted above, in some example approaches, computing device 134 includes a policy control system 130. FIG. 9 is a block diagram illustrating an example policy control system, in accordance with techniques of this disclosure. In the example approach of FIG. 9, policy control system 130 executes in external computing device 134 and responds to requests from computing device 116 for policies to use in response to diminished or modified sensor capabilities as measured by sensor capability assessment system 128. In some example approaches, policy control system 130 may include information provided by one or more pathway article messages 126. In some examples, policy control system 130 is configured to store and maintain information related to navigation of a temporary zone.

In the approach shown in FIG. 9, a policy scoring system 500 applies policies retrieved from a policy datastore 502 to determine a confidence level based on a determination of the sensor capabilities of one or more sensors in a PAAV 100. In one such example approach, each sensor reads information from pathway articles, extracts a pathway message and detects sensor accuracy measurement features within the message. In an image sensor, the sensor accuracy measurement features may, for instance, be specific indicia within an image. In one such approach, policy scoring system 500 applies a SIFT approach to determine the number of sensor accuracy measurement features detected by the sensor in the pathway message 126 and compares the number to the number of features expected to be found in the pathway message and calculates a confidence level accordingly. For instance, in one such approach, if an image capture device 102 retrieves an image but is only able to find 7 out of 10 features in the image, the confidence level computed for the image capture device is 70%. Similar calculations are performed for other sensor modalities.

In one such example approach, policy datastore 502 stores policies, received from one or more parties, on responding to changes in sensor capabilities. Policy control system 130 may be configured to receive a request for a policy indicated by pathway article message 126, look up the policy indicated by pathway article message 126, and output the policy indicated by pathway article message 126 to vehicle control component 144 for use with the capabilities measured by sensor capability assessment system 128. A policy might state that, for a PAAV 110 to operate at a certain level of autonomy, each of its sensors must operate at above a 60% confidence level. Otherwise, operation is restricted to a lower level of autonomy. An advantage of such an approach is that it not only considers the capabilities of the sensors but can also be used to consider other external factors as well, such as weather, cybercriminal attack or lack of light.

In some example approaches, policy scoring system 500 may weight contributions of different sensors to give more weight to selected sensors in certain environments. For instance, a policy scoring system 500 might want to favor image capture devices in daytime but LiDAR systems at night. At the same time, the number of features to be detected by a sensor for a given confidence level may vary according to the environment PAAV 110 will be operating in.

Other approaches can be used to determine a confidence level for each sensor. In one example approach, distance metric learning may be used to compute dissimilarity of signals from a variety of sources. Distance metric learning algorithms are formulated to use machine learning to discover a metric which describes the similarity (or dissimilarity) of two objects, or digital signals.

More specifically the algorithms learn a function d(x,y) where x and y are two distinct signals or feature sets derived from two distinct signals, which are expected to contain the same content. d(x,y) is the metric or score which determines the degree of similarity between the signals.

As typical with learning algorithms, m is learnt based on a large training dataset of signals where pairwise similarity is known in advance. The training data would consist of a collection of data points {x1, x2, . . . , xn}, where n is the number of samples in the collection. Each xiϵ|R\hat{ }m is a feature vector or digital signal. The similarity between pairs would either be defined based on a probabilistic or binary similar metric and could be represented as a matrix S, where the elements are s_ij define the similarity between signal x_i and x_j.

It should be noted that whilst this methodology has been framed as a machine learning problem, a solution can be hard coded by experts. In the simplest sense, d(x,y) could be defined as;

d(x,y)=sum_i(|x_i−y_i)

This metric is known generally as the L1 norm.

This generalized framework enables the system to provide a vehicle health check for a number of sensors including radar, sonar, etc. The generalization also enables a common architecture.

In another example approach, multi-sensor fusion is used to perform a health check of PAAV 110 based on sensor accuracy measurement features sensed across sensors of various modalities. Multi-sensor fusion in this case refers to situation where a complex interaction exists between sensors. For example, in one approach, the health check applies a sophisticated policy decision which assesses the overall system as opposed to the component sensor parts. The radar quality required for a certain level of autonomy might, for instance, be based on the health check of other components of PAAV 110.

In another example approach, a highway authority establishes a policy that governs whether a car has met satisfactory standards by observing the variations of the distance metric from the average recorded by PAAVs 110 on the road. Statistical variances in car metric performances could be measured over a time window. In one example approach, for instance, the policy may apply a laxer approach to determine is the sensor capabilities of the PAAV are sufficient to move along pathway 106. Instead of a strict threshold, a more flexible threshold allows vehicles that are performing poorly in sensor capability to continue down pathway 106. That is, sensor capability alone is not used to determine if a PAAV 110 can proceed. Instead, a car which is performing unusually poorly maybe highlighted as a potential risk/hazard. This could provide data independent of environmental effects.

Policy scoring system 500 also has utility in determining if a pathway 106 is safe. For instance, sensor capability measurements captured from a variety of PAAVs 110 in heavy or blowing snow may be used to determine if a road should be closed. In that case, traffic may be routed to other pathways 106.

Policy scoring system 500 also has utility in detecting if signs are damaged or missing. If most vehicles don't pass a sign's health check and there are no known environmental concerns, such as direct sun, snow, rain, it may be assumed the sign is the faulty component in the system. This provides automated asset management data. This feature would not need to be implemented on all signs, instead a sparse sample of signs could be monitored as barometers of health across a network. By understanding the deterioration of assets over time, asset maintenance could be scheduled and planned for cost effective safety.

In some example approaches, problems in the sign can be integrated in to the distance metric learning to ensure car health checks are accurate despite these changes.

Finally, policy scoring system 500 also has utility in diagnosing current or future problems in PAAV 110. For instance, in one example approach, policy scoring system 500 communicates with other PAAVs 110 to diagnose faults in PAAV 110. By computing multiple distance metrics and providing further analysis of the images retrieved from a pathway article, policy scoring system 500 can detect certain known defects. For example,

“car x is not fit for class 5 highway because the camera is not of high enough resolution”

“car x is not fit for class 5 highway because the camera appears to have a dirty lens, please resolve issue before trying to access”

“car x is not fit for class 5 highway because we believe the car is not behaving as expected, please take to a local garage for detail investigations”

“car x health check metrics are deteriorating at a rate of y, we predict a service of this component would be useful in z months”—this could reduce road risk/aid insurance premiums.

In some example approaches, road side unit 152 maintains, for one or more of the pathway articles, a crowd-sourced average sensor performance for the pathway article. In such an example approach, road side unit 152 uses the crowd-sourced average sensor performance associated with a given pathway article to determine sensor accuracy for vehicles passing by the pathway article. Such an approach is different than the previously described approach of storing an expected ground truth value associated with a specific sensor assessment sign and comparing that expected ground truth to the sign as read by a sensor. It may be used on any sign proximate a location where a large enough number of cars pass by the sign to meet a required sample size.

In another example approach, each PAAV 110 maintains a log of its accuracy performance relative to a specific group of pathway articles. For instance, a given PAAV 110 may pass the same set of pathway articles every day. In one example approach, computing device 116 maintains its own record of performance on a particular subset of signs (or other devices) which it then references against itself to maintain a calibration and performance standard. Such an approach may be used to detect and react to a slowly degrading sensor, or to determine that one or more of the expected signs are lost or damaged.

Comparison of the sensed data to the expected data will be discussed next. In one example approach, computing device 116 determines the dissimilarity between a pair of images (read vs expected) by identifying SIFT features in both the expected target image and the vehicle image. The similarity score would be high if common SIFT features were identified in the image pair. A high similarity score would provide confidence of the vehicle health. In one example approach, policy scoring system 500 weights SIFT features based on their saliency. Therefore, if it is more desirable to confirm a vehicle has identified specific features, these features could be weighted higher in the mathematical formulation. In other example approaches, policy scoring system 500 weights SIFT features as a function of environmental factors such as weather, as a function of type of pathway, as a function of resolution needed for each sensor, or as a function of types of modality. For instance, certain modalities may be more relevant to certain policies and are weighted accordingly.

In another example, many other opportunities exist for comparing the similarity of two signals. For instance, in some example approaches, policy scoring system 500 applies local adaptive distance metric learning. In other example approaches, policy scoring system 500 applies probabilistic distance metric learning. In other example approaches, policy scoring system 500 constructs a random forest to learn the probability of similar. This is generally achieved by observing which leaf node an example ends up in. In other example approaches, policy scoring system 500 applies methods based on SVM, or determines if unsupervised opportunities exist with manifold learning algorithm. In other example approaches, policy scoring system 500 applies semidefinite programming. In other example approaches, policy scoring system 500 applies a function that is invariant to noise. In other example approaches, policy scoring system 500 applies a function to detect noise. Finally, in some other example approaches, policy scoring system 500 applies a deep learning architecture formulated to learn metrics relevant to PAAV sensor capabilities, such as, for instance, approaches like context-based image retrieval.

In one example approach, policy scoring system 500 receives policies from different sources. As can be seen in FIG. 9, policies in policy datastore 502 include policies provided by the driver, by the vehicle manufacturer, by insurance companies, by the department of transportation and, in some approaches, policies defined by traffic laws. In one such example approach, a policy scoring system 500 applies the policies separately. In other such example approaches, policy scoring system 500 aggregates policies into a single policy encapsulating the policies received from each of the sources, noting and reporting any conflicts between policies.

In some example approaches, policy scoring system 500 records metrics captured from many vehicles and characterizes vehicles based on sensor capability performance. For instance, policy scoring system 500 may measure variance in vehicle population and identify cars that are struggling more than other cars, or types or brands of cars that are having difficulty in certain environments. Results are reported to a government or industry body for further analysis or may be distributed to other parties for other uses.

As noted above, in some example approaches, sensor capability testing may be driven by location. For instance, a sensor actively searches for pathway articles having sensor accuracy measurement features and reacts when they are detected. In some such example approaches, the pathway article also includes an indication of the policy or policies to be applied. For instance, in one example approach, the pathway article provides metadata used to query the road side unit for the policy to be used.

In some such example approaches, the pathway article includes metadata indicating the sensor modalities to be tested.

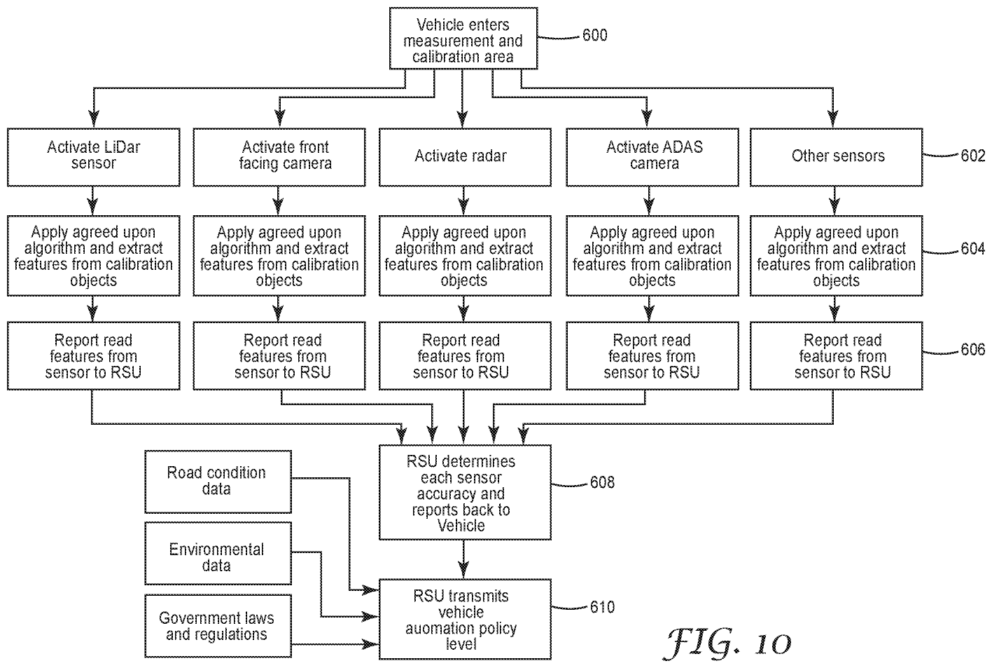

FIG. 10 is a flow chart illustrating an example method of determining a level of autonomy allowed to a vehicle, in accordance with techniques of this disclosure. As can be seen in FIG. 10, a vehicle enters a measurement a calibration area (600), activates one or more sensors to read provided sensor measurement accuracy features (also known as “calibration objects”) (602), applies agreed upon algorithms and extracts features from the calibration objects (604), and reports such features to the road side unit (606). The road side unit determines a sensor accuracy for each sensor and reports the sensor accuracy back to the vehicle (608). The road side unit then determines a permitted level of automation for the vehicle based on policies driven by the sensor accuracy and one or more of road condition data, environmental data, and government laws and regulations (610). As noted above, the entirety of the method described in terms of FIG. 10 may be performed in computing device 116 or in road side unit 152 or may be distributed in various ways between them.

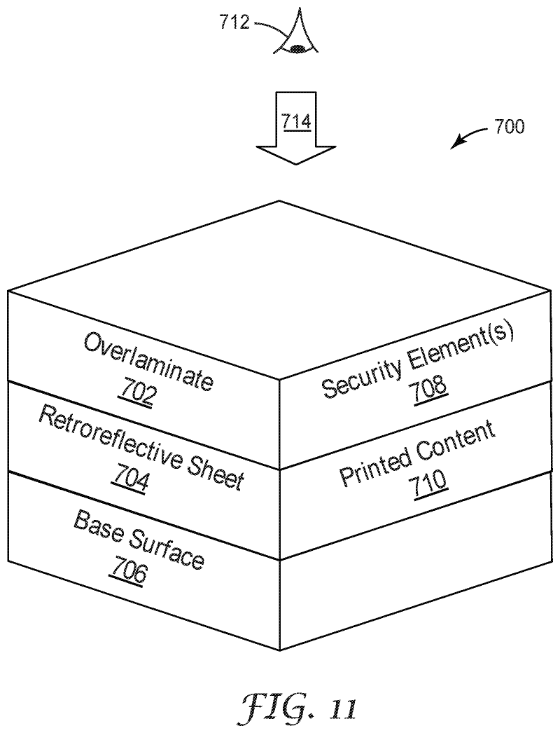

FIG. 11 is a conceptual diagram of a cross-sectional view of a pathway article in accordance with techniques of this disclosure. In some examples, such as an enhanced sign, a pathway article may comprise multiple layers. For purposes of illustration in FIG. 11, a pathway article 700 may include a base surface 706. Base surface 706 may be an aluminum plate or any other rigid, semi-rigid, or flexible surface. Retroreflective sheet 704 may be a retroreflective sheet as described in this disclosure. A layer of adhesive (not shown) may be disposed between retroreflective sheet 704 and base surface 706 to adhere retroreflective sheet 704 to base surface 706.

Pathway article may include an overlaminate 702 that is formed or adhered to retroreflective sheet 704. Overlaminate 702 may be constructed of a visibly-transparent, infrared opaque material, such as but not limited to multilayer optical film as disclosed in U.S. Pat. No. 8,865,293, which is expressly incorporated by reference herein in its entirety. In some construction processes, retroreflective sheet 704 may be printed and then overlaminate 702 subsequently applied to reflective sheet 704. A viewer 712, such as a person or image capture device, may view pathway article 700 in the direction indicated by the arrow 714.

As described in this disclosure, in some examples, an article message, such as pathway article message 126 of FIG. 1, may be printed or otherwise included on a retroreflective sheet. In such examples, an overlaminate may be applied over the retroreflective sheet, but the overlaminate may not contain an article message. In the example of FIG. 6, visible portions 710 of the article message may be included in retroreflective sheet 704, but non-visible portions 708 of the article message may be included in overlaminate 702. In some examples, a non-visible portion may be created from or within a visibly-transparent, infrared opaque material that forms an overlaminate. European publication No. EP0416742 describes recognition symbols created from a material that is absorptive in the near infrared spectrum but transparent in the visible spectrum. Suitable near infrared absorbers/visible transmitter materials include dyes disclosed in U.S. Pat. No. 4,581,325. U.S. Pat. No. 7,387,393 describes license plates including infrared-blocking materials that create contrast on a license plate. U.S. Pat. No. 8,865,293 describes positioning an infrared-reflecting material adjacent to a retroreflective or reflective substrate, such that the infrared-reflecting material forms a pattern that can be read by an infrared sensor when the substrate is illuminated by an infrared radiation source. EP0416742 and U.S. Pat. Nos. 4,581,325, 7,387,393 and 8,865,293 are herein expressly incorporated by reference in their entireties. In some examples, overlaminate 702 may be etched with one or more visible or non-visible portions.

In some examples, if overlaminate includes non-visible portions 708 and retroreflective sheet 704 includes visible portions 710 of article message, an image capture device may capture two separate images, where each separate image is captured under a different lighting spectrum or lighting condition. For instance, the image capture device may capture a first image under a first lighting spectrum that spans a lower boundary of infrared light to an upper boundary of 900 nm. The first image may indicate which encoding units are active or inactive. The image capture device may capture a second image under a second lighting spectrum that spans a lower boundary of 900 nm to an upper boundary of infrared light. The second image may indicate which portions of the article message are active or inactive (or present or not present). Any suitable boundary values may be used. In some examples, multiple layers of overlaminate, rather than a single layer of overlaminate 702, may be disposed on retroreflective sheet 704. One or more of the multiple layers of overlaminate may have one or more portions of the article message. Techniques described in this disclosure with respect to the article message may be applied to any of the examples described in FIG. 11 with multiple layers of overlaminate.

In some examples, a laser in a construction device may engrave the article message onto sheeting, which enables embedding markers specifically for predetermined meanings. Example techniques are described in U.S. Provisional Patent Application 62/264,763, filed on Dec. 8, 2015, which is hereby incorporated by reference in its entirety. In such examples, the portions of the article message in the pathway article can be added at print time, rather than being encoded during sheeting manufacture. In some examples, an image capture device may capture an image in which the engraved security elements or other portions of the article message are distinguishable from other content of the pathway article. In some examples the article message may be disposed on the sheeting at a fixed location while in other examples, the article message may be disposed on the sheeting using a mobile construction device, as described above.

The following examples provide other techniques for creating portions of the article message in a pathway article, in which some portions, when captured by an image capture device, may be distinguishable from other content of the pathway article. For instance, a portion of an article message, such as a security element may be created using at least two sets of indicia, wherein the first set is visible in the visible spectrum and substantially invisible or non-interfering when exposed to infrared radiation; and the second set of indicia is invisible in the visible spectrum and visible (or detectable) when exposed to infrared. Patent Publication WO/2015/148426 (Pavelka et al) describes a license plate comprising two sets of information that are visible under different wavelengths. The disclosure of WO/2015/148426 is expressly incorporated herein by reference in its entirety. In yet another example, a security element may be created by changing the optical properties of at least a portion of the underlying substrate. U.S. Pat. No. 7,068,434 (Florczak et al), which is expressly incorporated by reference in its entirety, describes forming a composite image in beaded retroreflective sheet, wherein the composite image appears to be suspended above or below the sheeting (e.g., floating image). U.S. Pat. No. 8,950,877 (Northey et al), which is expressly incorporated by reference in its entirety, describes a prismatic retroreflective sheet including a first portion having a first visual feature and a second portion having a second visual feature different from the first visual feature, wherein the second visual feature forms a security mark.

The different visual feature can include at least one of retroreflectance, brightness or whiteness at a given orientation, entrance or observation angle, as well as rotational symmetry. Patent Publication No. 2012/281285 (Orensteen et al), which is expressly incorporated by reference in its entirety, describes creating a security mark in a prismatic retroreflective sheet by irradiating the back side (i.e., the side having prismatic features such as cube corner elements) with a radiation source. U.S. Patent Publication No. 2014/078587 (Orensteen et al), which is expressly incorporated by reference in its entirety, describes a prismatic retroreflective sheet comprising an optically variable mark. The optically variable mark is created during the manufacturing process of the retroreflective sheet, wherein a mold comprising cube corner cavities is provided. The mold is at least partially filled with a radiation curable resin and the radiation curable resin is exposed to a first, patterned irradiation. Each of U.S. Pat. Nos. 7,068,464, 8,950,877, US 2012/281285 and US 2014/078587 are expressly incorporated by reference in its entirety.

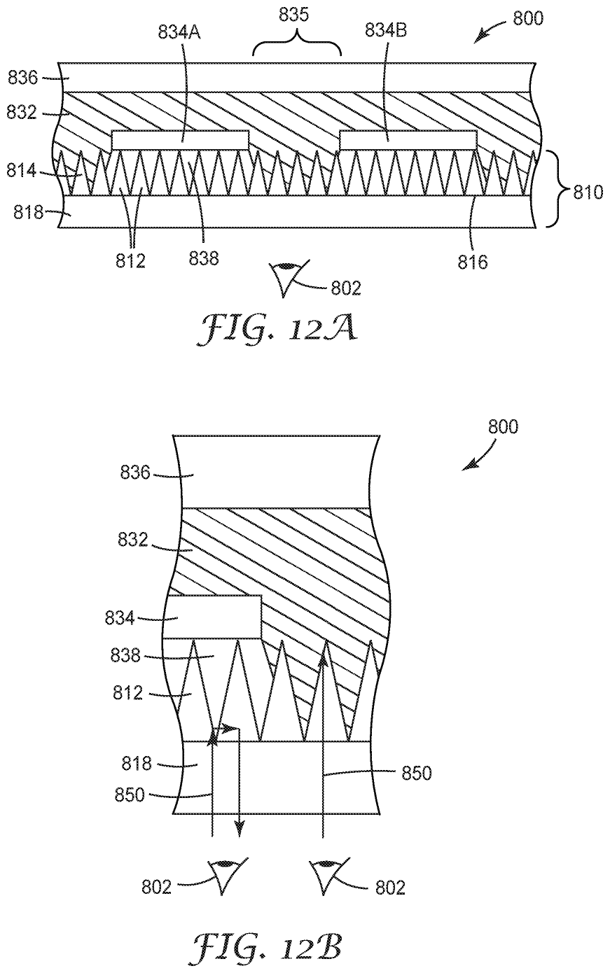

FIGS. 12A and 12B illustrate cross-sectional views of portions of an article message formed on a retroreflective sheet, in accordance with one or more techniques of this disclosure. Retroreflective article 800 includes a retroreflective layer 810 including multiple cube corner elements 812 that collectively form a structured surface 814 opposite a major surface 816. The optical elements can be full cubes, truncated cubes, or preferred geometry (PG) cubes as described in, for example, U.S. Pat. No. 7,422,334, incorporated herein by reference in its entirety. The specific retroreflective layer 810 shown in FIGS. 12A and 12B includes a body layer 818, but those of skill will appreciate that some examples do not include an overlay layer. One or more barrier layers 834 are positioned between retroreflective layer 810 and conforming layer 832, creating a low refractive index area 838. Barrier layers 834 form a physical “barrier” between cube corner elements 812 and conforming layer 832. Barrier layer 834 can directly contact or be spaced apart from or can push slightly into the tips of cube corner elements 812. Barrier layers 834 have a characteristic that varies from a characteristic in one of (1) the areas 832 not including barrier layers (view line of light ray 850) or (2) another barrier layer 832. Exemplary characteristics include, for example, color and infrared absorbency.

In general, any material that prevents the conforming layer material from contacting cube corner elements 812 or flowing or creeping into low refractive index area 838 can be used to form the barrier layer Exemplary materials for use in barrier layer 834 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers can be varied. In some examples, the barrier layers may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images lines, and intersecting zones that form cells.

The low refractive index area 838 is positioned between (1) one or both of barrier layer 834 and conforming layer 832 and (2) cube corner elements 812. The low refractive index area 838 facilitates total internal reflection such that light that is incident on cube corner elements 812 adjacent to a low refractive index area 838 is retroreflected. As is shown in FIG. 12B, a light ray 850 incident on a cube corner element 812 that is adjacent to low refractive index layer 838 is retroreflected back to viewer 802. For this reason, an area of retroreflective article 800 that includes low refractive index layer 838 can be referred to as an optically active area. In contrast, an area of retroreflective article 800 that does not include low refractive index layer 838 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 838 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 812 or flowing or creeping into low refractive index area 838 can be used as the low refractive index material. In some examples, barrier layer 834 has sufficient structural integrity to prevent conforming layer 832 from flowing into a low refractive index area 838. In such examples, low refractive index area may include, for example, a gas (e.g., air, nitrogen, argon, and the like). In other examples, low refractive index area includes a solid or liquid substance that can flow into or be pressed into or onto cube corner elements 812. Exemplary materials include, for example, ultra-low index coatings (those described in PCT Patent Application No. PCT/US2010/031290), and gels.

The portions of conforming layer 832 that are adjacent to or in contact with cube corner elements 812 form non-optically active (e.g., non-retroreflective) areas or cells. In some examples, conforming layer 832 is optically opaque. In some examples conforming layer 832 has a white color.

In some examples, conforming layer 832 is an adhesive. Exemplary adhesives include those described in PCT Patent Application No. PCT/US2010/031290. Where the conforming layer is an adhesive, the conforming layer may assist in holding the entire retroreflective construction together and/or the viscoelastic nature of barrier layers 834 may prevent wetting of cube tips or surfaces either initially during fabrication of the retroreflective article or over time.

In some examples, conforming layer 832 is a pressure sensitive adhesive. The PSTC (pressure sensitive tape council) definition of a pressure sensitive adhesive is an adhesive that is permanently tacky at room temperature which adheres to a variety of surfaces with light pressure (finger pressure) with no phase change (liquid to solid). While most adhesives (e.g., hot melt adhesives) require both heat and pressure to conform, pressure sensitive adhesives typically only require pressure to conform. Exemplary pressure sensitive adhesives include those described in U.S. Pat. No. 6,677,030. Barrier layers 834 may also prevent the pressure sensitive adhesive from wetting out the cube corner sheeting. In other examples, conforming layer 832 is a hot-melt adhesive.

In some examples, a pathway article may use a non-permanent adhesive to attach the article message to the base surface. This may allow the base surface to be re-used for a different article message. Non-permanent adhesive may have advantages in areas such as roadway construction zones where the vehicle pathway may change frequently.

In the example of FIG. 12A, a non-barrier region 835 does not include a barrier layer, such as barrier layer 834. As such, light may reflect with a lower intensity than barrier layers 834A-834B. In some examples, non-barrier region 835 may correspond to an “active” security element. For instance, the entire region or substantially all of image region 142A may be a non-barrier region 835. In some examples, substantially all of image region 142A may be a non-barrier region that covers at least 50% of the area of image region 142A. In some examples, substantially all of image region 142A may be a non-barrier region that covers at least 75% of the area of image region 142A. In some examples, substantially all of image region 142A may be a non-barrier region that covers at least 90% of the area of image region 142A. In some examples, a set of barrier layers (e.g., 834A, 834B) may correspond to an “inactive” security element. In the aforementioned example, an “inactive” security element may have its entire region or substantially all of image region 142D filled with barrier layers. In some examples, substantially all of image region 142D may be a non-barrier region that covers at least 75% of the area of image region 142D. In some examples, substantially all of image region 142D may be a non-barrier region that covers at least 90% of the area of image region 142D. In the foregoing description of FIG. 7 with respect to security layers, in some examples, non-barrier region 835 may correspond to an “inactive” security element while an “active” security element may have its entire region or substantially all of image region 142D filled with barrier layers.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A system, comprising:
a pathway article assisted vehicle (PAAV) having one or more sensors;
one or more sensor accuracy measurement features deployed along a pathway; and
at least one computing device comprising one or more processors connected to memory, wherein the memory includes instructions that, when executed by the one or more processors, cause the processors to:
receive captured sensor data from each respective sensor, the captured sensor data generated by sensing, with the respective sensor, at least one of the sensor accuracy measurement features deployed along the pathway;
determine a sensing capability for the PAAV, wherein the sensing capability for the PAAV is based at least in part on the captured sensor data for each respective sensor and of expected sensor data for each respective sensor; and
perform at least one operation of the PAAV as a function of at least one policy applied to the sensing capability determined for the PAAV.

2. The system of claim 1, wherein determining the sensing capability for the PAAV includes generating an assessment score for each respective sensor.

3. The system of claim 1, wherein a sensing capability for the PAAV includes generating a confidence score for each respective sensor, the confidence score reflecting perceived effectiveness of the respective sensor.

4. The system of claim 1, wherein the one or more sensors includes a first sensor and a second sensor,
wherein the captured sensor data includes captured sensor data generated by the first sensor by sensing, with the first sensor, at least one of the sensor accuracy measurement features deployed along the pathway and captured sensor data generated by the second sensor by sensing, with the second sensor, at least one of the sensor accuracy measurement features deployed along the pathway, and
wherein determining the sensing capability for the PAAV includes generating a combined confidence score for the first and second sensors, the combined confidence score indicating perceived effectiveness of operation of the first and second sensors in combination.

5. The system of claim 4, wherein generating a combined confidence score for the first and second sensors includes:
calculating a sensor accuracy for the first sensor; and
calculating a sensor accuracy for the second sensor, and
wherein the combined confidence score for the first and second sensors is a function of a weighted version of the sensor accuracy calculated for the first sensor to a weighted version of the sensor accuracy calculated for the second sensor.

6. The system of claim 4, wherein performing at least one operation of the PAAV as a function of at least one policy applied to the sensing capability determined for the PAAV includes applying the at least one policy to the combined confidence score for the first and second sensors.

7. The system of claim 1, wherein the computing devices direct the sensors to sense the one or more sensor accuracy measurement features on the pathway.

8. The system of claim 1, wherein the computing devices direct the sensors to sense the one or more sensor accuracy measurement features on the pathway based on location.

9. The system of claim 1, wherein the at least one policy includes one or more policies established by a first party and one or more policies established by a second party.

10. The system of claim 1, wherein performing at least one operation of the PAAV as a function of at least one policy applied to the sensing capability determined for the PAAV includes:
providing a hierarchy of policies; and
selecting policies to apply based on the hierarchy.

11. The system of claim 1,
wherein the PAAV has a current level of automation, and
wherein performing at least one operation of the PAAV as a function of at least one policy applied to the sensing capability determined for the PAAV includes:
determining, based on the determined sensing capability of the PAAV and the at least one policy, whether the PAAV can operate at the current level of automation, and
downgrading the PAAV to a lower level of automation if the PAAV cannot operate at its current level of automation.

12. The system of claim 1, wherein performing at least one operation of the PAAV as a function of at least one policy applied to the sensing capability determined for the PAAV includes calibrating at least one PAAV sensor.

13. The system of claim 1, wherein the memory further includes instructions that, when executed by the one or more processors, cause the processors to:
determine a sensor accuracy for one or more of the respective sensors based on the captured sensor data received from each respective sensor;
compare sensor accuracies determined for each respective sensor to sensor accuracies determined for similar sensors in other PAAVs based on sensing the same one or more sensor accuracy measurement features; and
adjust the sensing capability determined for the PAAV based on the comparison.

14. The system of claim 1, wherein the memory further includes instructions that, when executed by the one or more processors, cause the processors to:
determine a sensor accuracy for one or more of the respective sensors based on the captured sensor data received from each respective sensor;
compare sensor accuracies determined for each respective sensor to sensor accuracies determined for similar sensors in other PAAVs based on sensing the same one or more sensor accuracy measurement features; and
report sensor accuracy measurement features on the pathway that consistently generate lower sensor accuracy determinations.

15. The system of claim 2, wherein the memory further includes instructions that, when executed by the one or more processors, cause the processors to:
compare the assessment score for each respective sensor to assessment scores of similar sensors in other PAAVs based on sensing the same one or more sensor accuracy measurement features; and
report sensor accuracy measurement features on the pathway that consistently generate lower assessment scores.

16. The system of claim 1, wherein the computing device is a road side unit.

17. The system of claim 16, wherein the road side unit is communicatively coupled to the PAAV through Dedicated Short-Range Communications (DSRC).

18. The system of claim 1, wherein the memory further includes instructions that, when executed by the one or more processors, cause the processors to receive, from a road side unit, the expected sensor data expected to be captured by the respective sensor when sensing at least one of the one or more sensor accuracy measurement features on the pathway.

19-26. (canceled)

27. A road-side unit comprising:
an interface;
a memory; and
one or more processors coupled to the memory, the memory comprising instructions that, when executed by the one or more processors, cause the processors to:
output, via the interface, an indication of upcoming one or more sensor accuracy measurement features on a pathway, the sensor accuracy measurement features detectable by a system comprising a pathway article assisted vehicle (PAAV) having one or more sensors for respective sensor modalities, for evaluating sensor accuracy for each of the one or more sensors.

28. The road-side unit of claim 27, wherein the memory further comprises instructions that, when executed by the one or more processors, cause the processors to:
output, via the interface, expected sensor data expected to be captured by at least one of the one or more sensors when sensing at least one of the one or more sensor accuracy measurement features on the pathway.

29-36. (canceled)
